(19) United States
(12) Patent Application Publication
(10) Pub. No.: US 2026/0153911 A1
(43) Pub. Date: Jun. 4, 2026

(54) ADAPTIVE LIQUID COOLING SYSTEM

(71) Applicant: OpenAI OpCo, LLC., San Francisco, CA (US)

(72) Inventors: Chian-min Richard Ho, Palo Alto, CA (US); Reza H. Khiabnani, San Mateo, CA (US)

(73) Assignee: OpenAI OpCo, LLC., San Francisco, CA (US)

(21) Appl. No.: 18/966,950

(22) Filed: Dec. 3, 2024

(51) Int. Cl. G06F 1/20

(52) U.S. Cl. CPC G06F 1/20

(57) ABSTRACT

The present technology pertains to a system for cooling heat-producing systems (e.g., computing and information technology components) in a data center. The data center includes cells that have multiple subdivisions, and each subdivision includes primary coolant distribution units (CDUs) without backup CDUs (i.e., a CDU that is dormant until a primary CDUs fails). Opened valves between the subdivisions enable coolant from subdivisions having excess cooling capacity to flow to a failing subdivision that lacks sufficient cooling capacity to fully remove the heat produced by the heat-producing systems in the failing subdivision. Thus, the excess cooling capacity of the subdivisions can provide cooling redundancy to compensate for failing CDUs obviating the need for backup CDUs. The rows can be partitioned into failure domains such that a failure domain is isolated from cooling failures in other failure domains. The partitioning between failure domains can be reconfigured as needed.

### BACKGROUND

A data center can be a building, a dedicated space within a building, or a group of buildings that are used to house information technology (IT) equipment such as computer systems and associated components (e.g., routers, switches, computer storage, and security appliances). IT equipment produces heat that, if not removed, can elevate the temperature of the IT equipment above the specified temperature range within which the IT equipment is safe to operate. Operating at temperatures outside the specified temperature range may damage the IT equipment.

Both air and liquid cooling can be used in data centers to cool the IT equipment. A liquid cooling system for a data center is designed to manage the heat produced by high-density computing equipment, such as central processing units (CPUs) and graphics processing units (GPUs). Liquid cooling can be more efficient and effective than traditional air cooling for high-performance and large-scale data centers. For example, water has a much higher thermal conductivity than air, enabling water to absorb and transfer heat more quickly than air. Further liquid cooling systems can remove heat more efficiently than air cooling, making it effective in high-density server environments.

Air cooling systems, such as computer room air conditioning (CRAC) units, use more space to circulate cool air throughout the data center, whereas liquid cooling systems can be more compact reducing the need for bulky cooling infrastructure. Additionally, liquid cooling can be more energy-efficient than air cooling because it requires less power to move liquid than to circulate air. Further, liquid cooling can be quieter than air cooling because the fans used for air cooling can generate significant noise.

High-density workloads (such as those found in modern GPUs, AI workloads, or high-performance computing) generate significant heat. Liquid cooling can support much higher thermal loads and is capable of cooling more densely packed components in a smaller space. Also, liquid cooling can be scaled more easily in high-performance environments. As a data center grows and hardware density increases, liquid cooling systems can be expanded more efficiently than traditional air cooling. This scalability makes liquid cooling advantageous for modern, large-scale data centers.

### BRIEF DESCRIPTION OF THE SEVERAL VIEWS OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings, and the claims.

FIG. 1A illustrates a perspective view of a row in a liquid-cooled data center in accordance with some embodiments.

FIG. 1B illustrates a top view of a row in a liquid-cooled data center in accordance with some embodiments.

FIG. 1C illustrates a first example of a cell having two rows in accordance with some embodiments.

FIG. 1D illustrates a second example of a cell having two rows in accordance with some embodiments.

FIG. 2A illustrates an example of intra-cell valves connecting rows within respective cells in a liquid-cooled data center in accordance with some embodiments.

FIG. 2B illustrates an example of a controller sending control signals to the intra-cell valves and the inter-cell valves in accordance with some embodiments.

FIG. 2C illustrates an example of a controller receiving feedback signals from rows in a liquid-cooled data center in accordance with some embodiments.

FIG. 2D illustrates an example of supplementing the cooling in a failing row using the excess cooling capacity from a neighboring row in accordance with some embodiments.

FIG. 2E illustrates an example of supplementing the cooling in a failing row using the excess cooling capacity from two neighboring rows in accordance with some embodiments.

FIG. 2F illustrates an example of supplementing the cooling in a failing row using the excess cooling capacity from four neighboring rows in accordance with some embodiments.

FIG. 3 illustrates examples of open and closed states for a three-way valve in accordance with some embodiments.

FIG. 4A illustrates a method for compensating cooling failures in a row of a cooling system using the excess cooling capacity in one or more neighboring rows in accordance with some embodiments.

FIG. 4B illustrates a first example of a process for controlling the state of intra-cell and inter-cell valves to compensate for cooling deficits in a failing row in accordance with some embodiments.

FIG. 4C illustrates a second example of a process for controlling the state of intra-cell and inter-cell valves to compensate for cooling deficits in a failing row in accordance with some embodiments.

FIG. 5A illustrates a first example of an arrangement of intra-cell and inter-cell valves in a cooling system in accordance with some embodiments.

FIG. 5B illustrates a second example of an arrangement of intra-cell and inter-cell valves in a cooling system in accordance with some embodiments.

FIG. 5C illustrates a third example of an arrangement of a cooling system that uses inter-cell pumps to dictate flow direction and flow rates of the coolant in accordance with some embodiments.

FIG. 6A illustrates perspective view of an example of a square-grid topology for cells in a cooling system in accordance with some embodiments.

FIG. 6B illustrates a side view of the example of the square-grid topology for cells in the cooling system in accordance with some embodiments.

FIG. 6C illustrates a first example of partitioning cells/rows into failure domains in accordance with some embodiments.

FIG. 6D illustrates a second example of partitioning cells/rows into failure domains in accordance in accordance with some embodiments.

FIG. 6E illustrates a third example of partitioning cells into failure domains in accordance in accordance with some embodiments.

FIG. 7A illustrates an example of a hexagon-grid topology for cells/rows in a cooling system in accordance with some embodiments.

FIG. 7B illustrates an example of a triangle-grid topology for cells/rows in a cooling system in accordance with some embodiments.

FIG. 7C illustrates an example of a mixed hexagon and pentagon grid topology for cells/rows in a cooling system in accordance with some embodiments.

FIG. 8 shows an example of a computing system for implementing certain aspects of the present technology.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

In a data center, a liquid cooling system can be used for thermal management (i.e., heat removal) of heat produced by high-density computing equipment, such as central processing units (CPUs) and graphics processing units (GPUs). Liquid cooling can be more efficient and effective than traditional air cooling for high-performance and large-scale data centers. For example, water has a much higher thermal conductivity than air, enabling water to absorb and transfer heat more quickly and efficiently than air, making it effective in high-density server environments.

Cold plates can be installed on heat-producing components like CPUs or GPUs. These plates can directly contact the components to absorb the heat generated by the heat-producing components. The heat is transferred from the cold plate to a liquid coolant flowing through the cold plate.

The coolant can be a mixture of water and additives (e.g., glycols or biocides) that prevent freezing or corrosion. Further, the coolant can be non-conductive to avoid damaging electronics in case of leaks. For example, the coolant can be water-based (e.g., distilled water or deionized water) or a specialized coolant (e.g., a synthetic fluid). The coolant flows through a network of pipes or flexible tubing, connecting the cold plates attached to the servers to the heat exchangers or radiators.

Pumps circulate the coolant through the system where the coolant absorbs heat from the IT equipment and transports the heat to one or more heat exchangers that transfer the heat to the environment. That is, heat exchangers (or radiators) are used to dissipate the heat absorbed by the coolant into the surrounding environment. For example, the heat exchangers can be located outside the data center, transferring heat to the external environment directly.

According to certain non-limiting examples (e.g., large data centers or systems with large heat loads, chillers can be used to cool the coolant below ambient temperatures. Chillers are refrigeration units that cool the coolant before the coolant is circulated through the system.

Further, liquid cooling systems can be integrated with sensors, control units, and monitoring software that track the coolant's temperature, flow rate, and pressure. These systems can adjust the flow rate of the coolant or activate additional cooling measures to maintain optimal temperature levels.

In a data-center cooling system, the pump and chiller can be included in a cooling distribution unit (CDU) that provides liquid cooling to respective rows of a data center to remove heat from the IT equipment in a given row. Each row can have a primary CDU that is continuously operating to cool the IT equipment in that row. In certain implementations, the rows can also have backup CDUs that provide redundancy in case of failure of the primary CDU. The backup CDUs can remain dormant unless the primary CDU fails, in which case the backup CDU becomes active and takes over cooling duties until the primary CDU is repaired or replaced. This solution is less efficient because it doubles the number of CDUs and, therefore, doubles the cost associated with the CDUs.

The systems and methods disclosed herein provide a more efficient solution by using the excess cooling capacity of neighboring rows to compensate for a cooling capacity deficit in a failing row (i.e., a row in which the CDU is operating at diminished capacity or completely fails). For example, the CDU in each row can operate at some percentage (e.g., 66%) of its maximum heat-removal capacity. Further, valves can be provided between the rows, connecting the coolant loop from a row to its neighboring rows. Thus, when the CDU in one row fails, the valves to one or more neighboring rows can be opened such that the excess cooling capacity of the CDUs in these neighboring rows can be used to cool the information technology (IT) equipment in the failing row. Then, once the failing CDU is repaired, the valves can be closed, and the cells can go back to normal operation.

In the example in which each row only consumes 66% of the CDU’s maximum cooling capacity, each row has an excess cooling capacity of 34% that can be diverted to another row. If the CDU completely fails in a failing row, then 33% of the cooling capacity from two neighboring rows can be diverted to the failing row to compensate for the cooling capacity deficit resulting from the failing CDU. Alternatively, 22% of the cooling capacity from three neighboring rows can be diverted to the failing row leaving a safety margin of 12% excess cooling capacity in each of the three neighboring rows, and this safety margin can provide a buffer in case of fluctuations in the heat produced in the neighboring rows.

Further, the data center cooling system can be subdivided into failure domains. For example, a data center can consist of a plurality of cells, each cell can have multiple rows, and a row can include several racks of IT equipment, which are cooled by one or more primary CDUs without any backup CDUs. A cell can include intra-cell valves connecting the coolant loops of neighboring rows within the cell to each other. The intra-cell valves can be opened to use the excess cooling capacity from one row to cool another row in the cell (e.g., a failing row).

The cooling system can also include inter-cell valves that connect neighboring cells. By opening an inter-cell valve, the excess cooling capacity can be diverted from one cell to compensate for a cooling capacity deficit in another cell. For example, the inter-cell valves can be opened when the functioning CDUs within a given cell lack sufficient excess cooling capacity to completely offset the thermal load of a failing row within the given cell. In this case, one or more inter-cell valves are opened to neighboring rows within the given cell. If the excess cooling capacity of all the rows within the given cell is insufficient to cool the failing row, then neighboring cells can be relied on to provide the additional excess cooling capacity that is needed to cool the failing row. This additional excess cooling capacity from the neighboring cells is diverted to the failing cell by opening the inter-cell valves between the failing cell and the neighboring cells.

If the excess cooling capacity of all rows within a failure domain is still insufficient to cool the failing row, then the failing row can be isolated by closing the adjacent valves to the failing row and the IT equipment in the failing row can be powered down until the CDU in the failing row is repaired or replaced. Failure domains can be used to ensure that a failure in one of the failure domains does not adversely affect the remaining failure domains. The failure domains can be enforced by maintaining those inter-cell valves and/or intra-cell valves located along the boundaries between failure domains in a closed state, thereby preventing fluid communication of the coolant between failure domains.

The failure domains can be updated based on changes to the IT equipment. Consider the example in which new IT equipment can be installed in one or more rows, and the new IT equipment has a higher power density than the previous IT equipment. For example, the cooling capacity consumed in the row can increase from 66% to 75% of the CDU's maximum cooling capacity. In this case, larger failure domains might be used to account for the decrease in excess cooling capacity being available from the row to supplement failures in other rows.

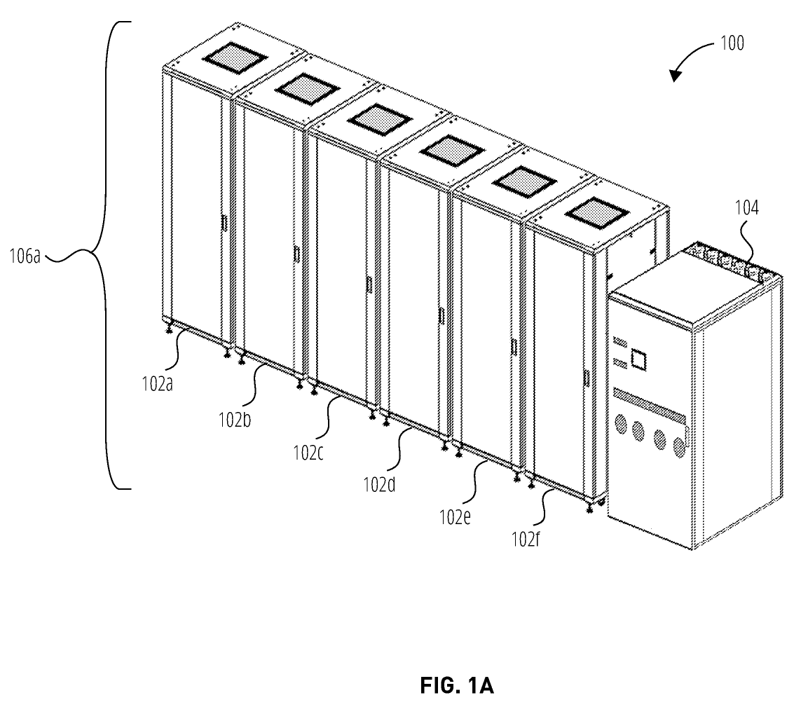

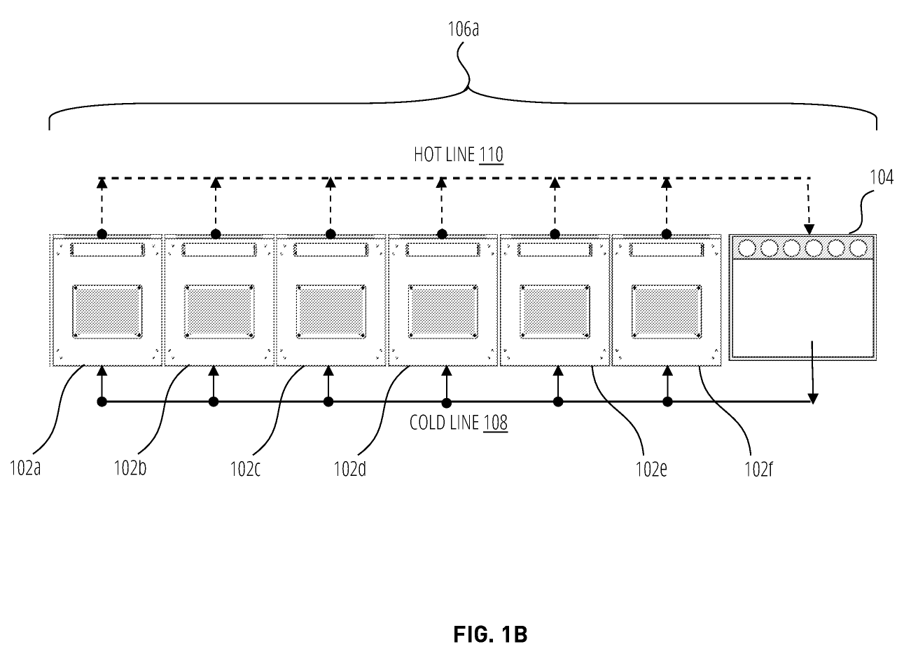

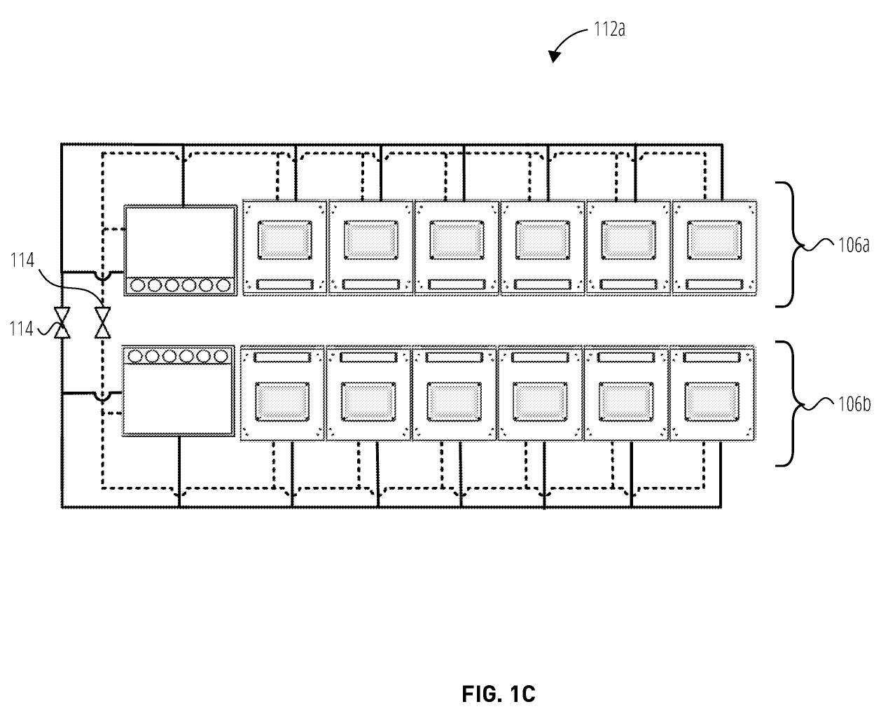

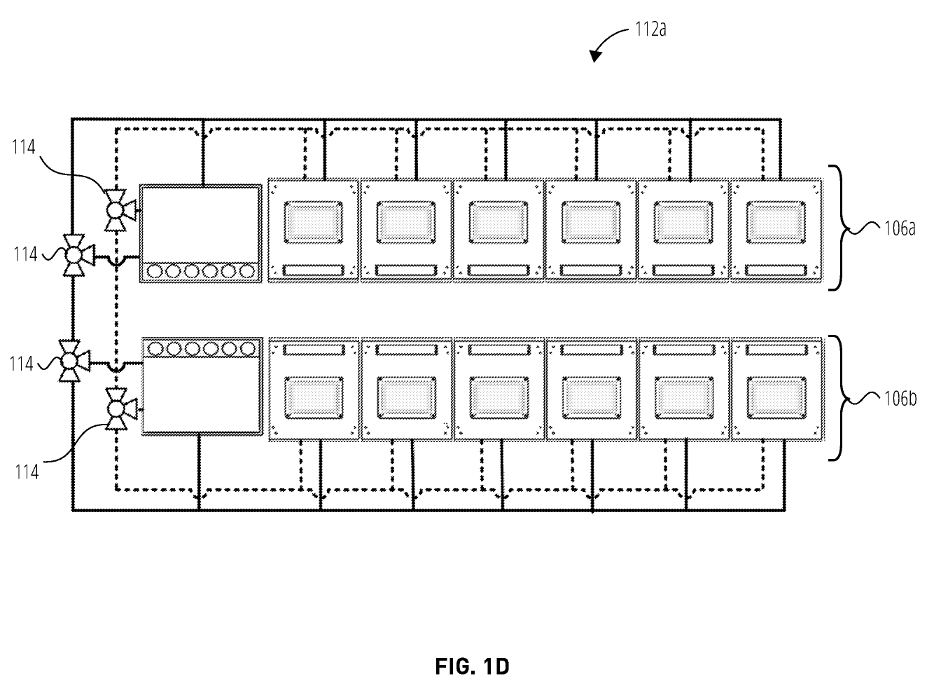

FIG. 1A illustrates an example of a liquid-cooled data center 100 that includes a row of IT equipment (e.g., network racks) that is cooled using liquid cooling. In this example, upper row 106a includes five racks of IT equipment (i.e., rack 102a, rack 102b, rack 102c, rack 102d, rack 102e, and rack 102f). These five racks can be cooled by a single coolant distribution unit (i.e., CDU 104).

Upper row 106a provides liquid cooling to the racks in the row by circulating a chilled coolant from CDU 104 to the racks where heat transfer from the IT equipment (e.g., servers) to the coolant removes heat from the IT equipment. In a closed-loop system, the heated coolant from the IT equipment returns to CDU 104 where the coolant is again chilled and sent back to the racks. That is, the heat produced by IT equipment is directly removed by the coolant. A coolant such as water can be more effective than air for removing heat due to the higher specific heat and higher thermal conductivity of water compared to air.

FIG. 1B illustrates a top view of an example of cooling IT equipment using liquid cooling. Cold line 108 distributes coolant from CDU 104 to the IT equipment in the respective racks. Hot line 110 provides a return path for the coolant from the racks to CDU 104.

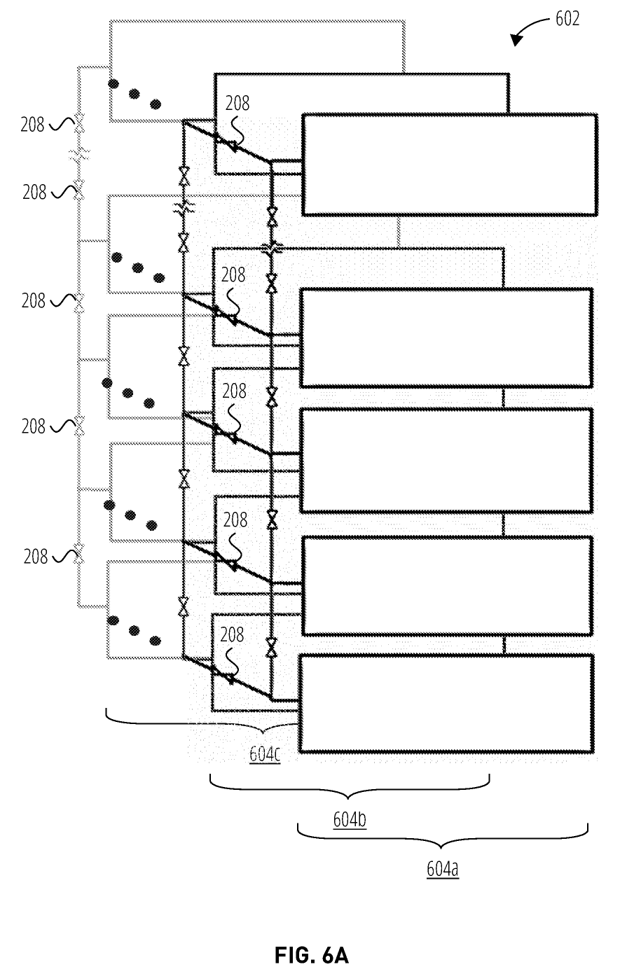

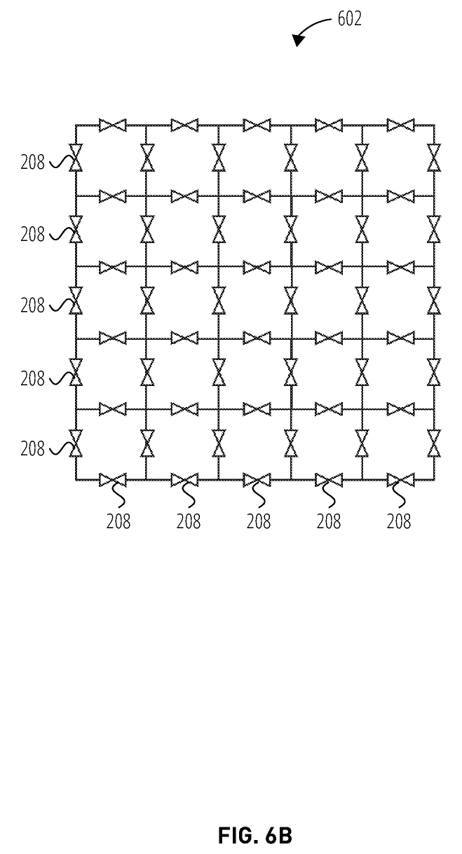

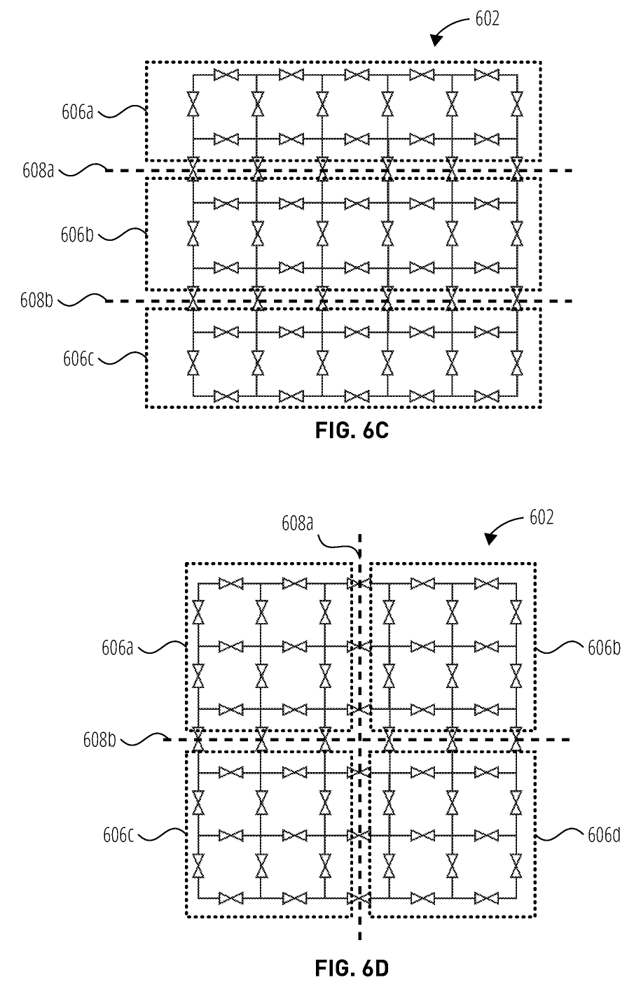

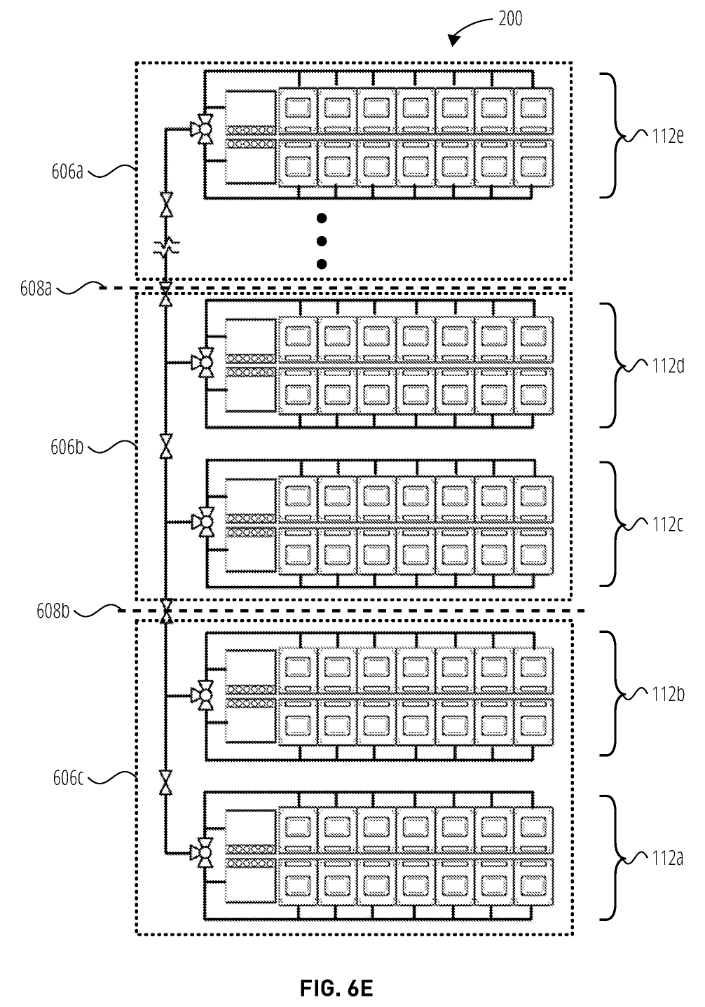

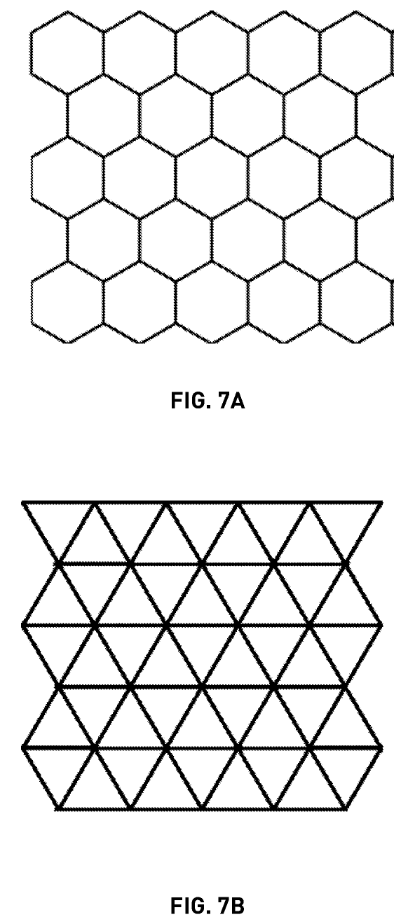

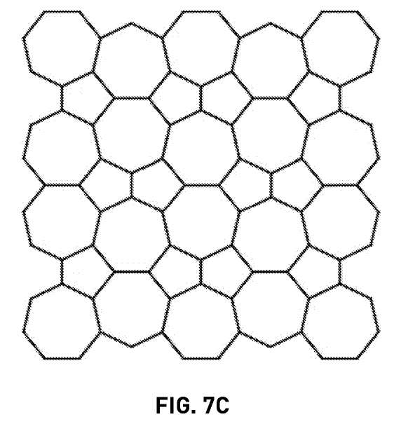

FIG. 1C illustrates an example of two rows (i.e., upper row 106a and lower row 106b) that are grouped to form cell 112a. Each row can be operated independently by closing intra-cell valves 114. If, however, the CDU in one of the rows fails or is functioning at diminished capacity, intra-cell valves 114 can be opened such that some of the cooling capacity of the CDU in the properly functioning row can compensate for the reduction of the capacity of the CDU in the failing row. FIG. 1C shows the non-limiting case of two rows per cell, but cells can include more than two rows with tubing and intra-cell valves 114 connecting each row with its neighboring rows. According to certain non-limiting examples, when the cell has more than two rows, each row can have two neighboring rows, such as in a ring topology. In other cell topologies, the rows can have more than two neighboring rows. For example, as illustrated below in FIG. 6A and FIG. 6B, in a square-grid topology, a row can have as many as three neighboring rows, and, in a triangle-grid topology, a row can have as many as six neighboring rows, as illustrated in FIG. 7B.

Consider the example of cells consisting of two rows and both rows in the cells are functionally the same. That is, the heat-producing system (e.g., IT equipment) in each row produces the same amount of heat and the CDU in each row has the same heat-removal capacity. When the cooling capacity of each CDU is twice the amount of heat produced by the respective rows, each CDU has 50% excess cooling capacity, or the heat produced by the IT equipment in the row consumes 50% of the CDU's maximum cooling capacity. In this case, a failure in one of the rows can be addressed by turning off the failing CDU and opening intra-cell valves 114 such that the functioning CDU can cool the racks in both rows. That is, the functioning CDU operates at maximum cooling capacity and sends half of the coolant to each row. According to certain non-limiting examples, to compensate for the doubling of the workload, the pump in the functioning CDU can be operated at twice the speed that would be used for a single row.

An excess cooling capacity of less than 50% can be sufficient to compensate for CDU failures when a cell includes more than two rows. In this case, more than one intra-cell valve 114 can be opened between the failing row and two or more of the neighboring rows, which provide their excess cooling capacity to compensate for the loss in the failing row. In a second example, if a failing row normally consumes 50% of the maximum cooling capacity and the failing row has two neighboring rows, then the cooling capacity deficit in the failing row can be compensated by opening intra-cell valves 114 to both of the neighboring rows and diverting 25% of the maximum capacity from these rows to the failing row.

In a third example, the heat produced in each row consumes 75% of the CDU's cooling capacity, leaving only 25% of the cooling capacity as excess cooling capacity that can be used to supplement failures or degradation of neighboring rows. If the cell includes four rows, then a failure of the CDU in one row could be compensated for using the 25% excess cooling capacity from each of the three other rows in the cell by opening all intra-cell valves 114 in the cell to allow a portion of the coolant from each of the other cells to flow through the failing row.

In a fourth example, the cooling capacity of a CDU may be diminished without completely failing. For example, a CDU operating at 50% of its maximum cooling capacity (also referred to as the specified capacity) may still be able to chill the coolant but at a diminished effectiveness. For example, when in its diminished condition, the CDU might only be capable of chilling the coolant to the required temperature when operating at 25% of its maximum pump rate. In this case, the cooling capacity of the CDU would be 25% of its maximum cooling capacity, which is less than 50% of the maximum cooling capacity that is consumed by the IT equipment in the row (i.e., the heat produced by the IT equipment). In this case, the CDU in the failing row may continue operating at its diminished capacity (i.e., at 25% of its maximum pumping rate) and the cooling capacity deficit (i.e., the difference between the heat produced by the row and the cooling capacity of the CDU) can be compensated for by coolant flowing from one or more other rows in the cell.

Consider the case in which each row consumes 75% of the maximum cooling capacity of the respective CDUs. When the CDU in one row operates at a diminished capacity of 25% of its maximum capacity, a cooling capacity deficit of 50% of the maximum capacity remains to be compensated by the other rows in the cell. This cooling capacity deficit of 50% can be compensated for by opening intra-cell valves 114 between the failing cell and two other rows in the cell, which each contribute 25% of the maximum cooling capacity of the CDU. According to certain non-limiting examples, the excess cooling capacity from the other rows is applied to the failing row by increasing the pumping rate in the CDUs in the other rows (e.g., operating the pumps in the other rows at their maximum pumping rate). For example, the pump in the failing CDU can be decreased to 25% of its maximum rate, and the pumping rate in each of the other rows can be increased by 100% of their maximum rate, such that 25% of the coolant (and 25% of the cooling capacity) from each of the other rows is diverted to the failing row.

FIG. 1D shows another non-limiting example of cell 112a. In this example, intra-cell valves 114 are three-way valves. In FIG. 1C, the amount of coolant provided from each CDU to the respective rows is determined based on the pressure (e.g., the pumping rate) at the output of the respective CDUs and based on how much fluid resistance is provided by intra-cell valve 114. For example, more coolant will flow between the rows when the valve is fully open as opposed to only being partially open, which narrows the aperture through which the coolant flows and increases the fluid resistance. In FIG. 1D, the three-way valves provide additional degrees of freedom for controlling the amount of coolant flowing to the respective rows (e.g., the relative amounts of cooling capacity contributed by each of the rows).

Other valve combinations can also be used. For example, cold line 108 can use two valves that are three-way valves, as shown in FIG. 1D, but hot line 110 can use a single valve that is a two-way valve, as shown in FIG. 1C. Alternatively, hot line 110 can be connected between the rows without an intra-cell valve.

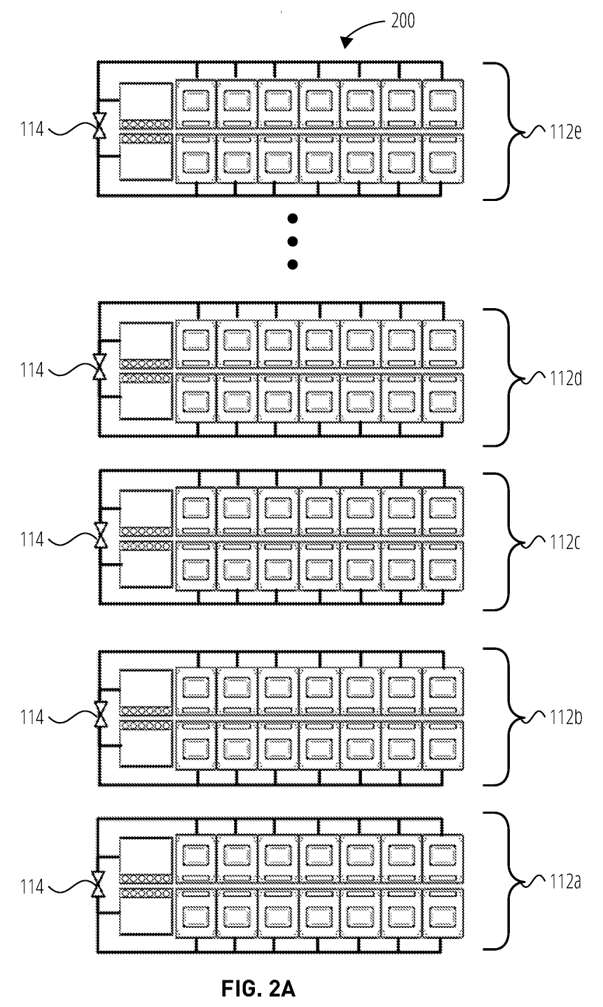

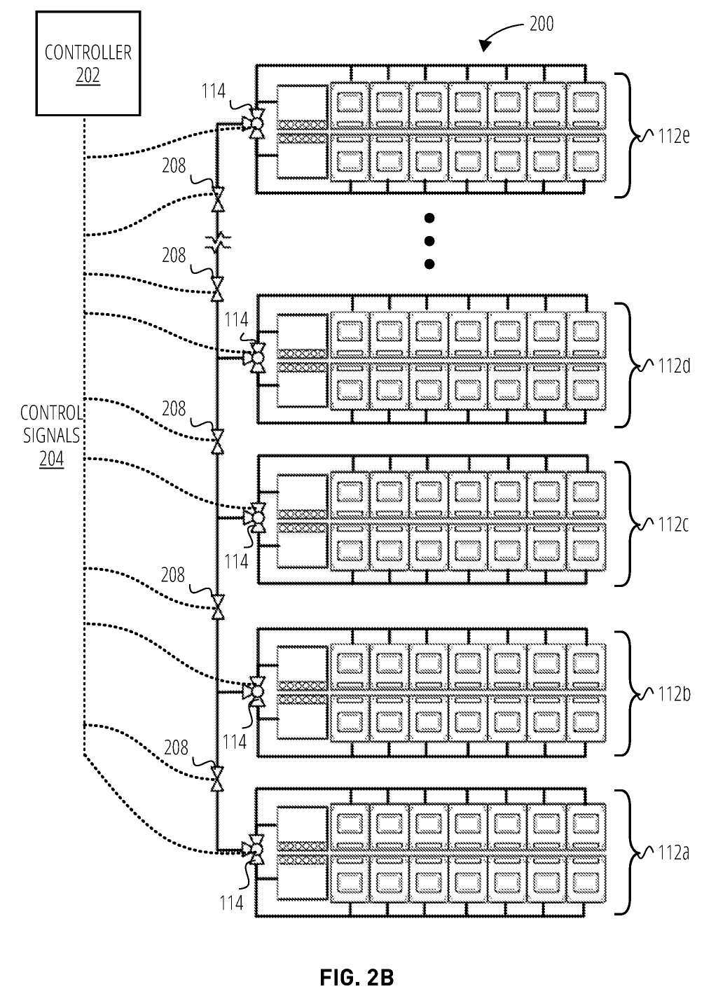

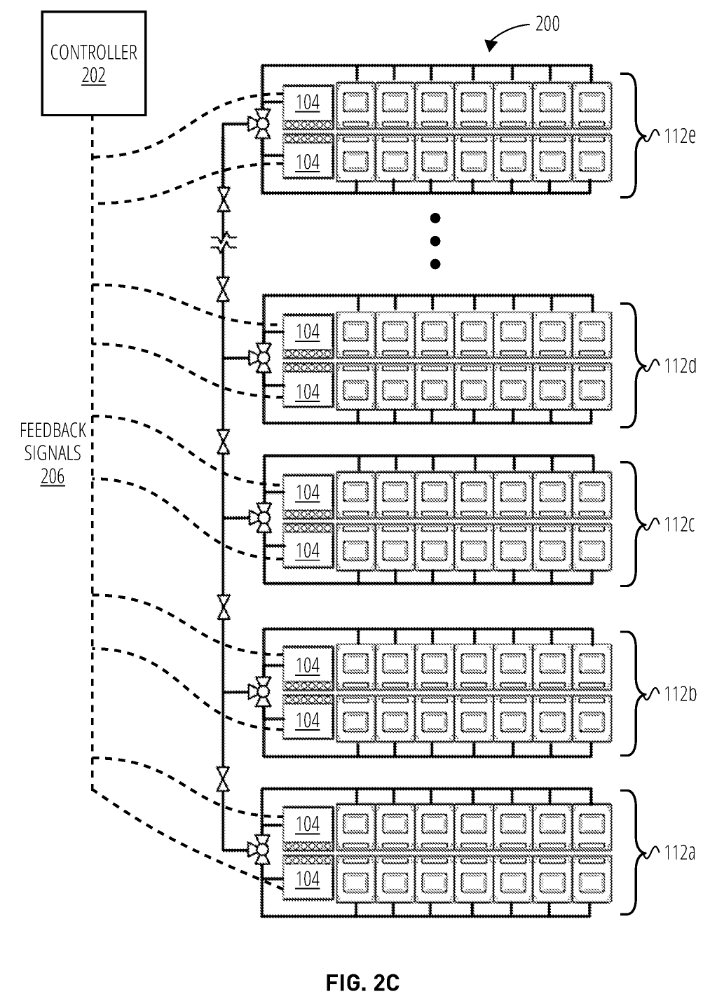

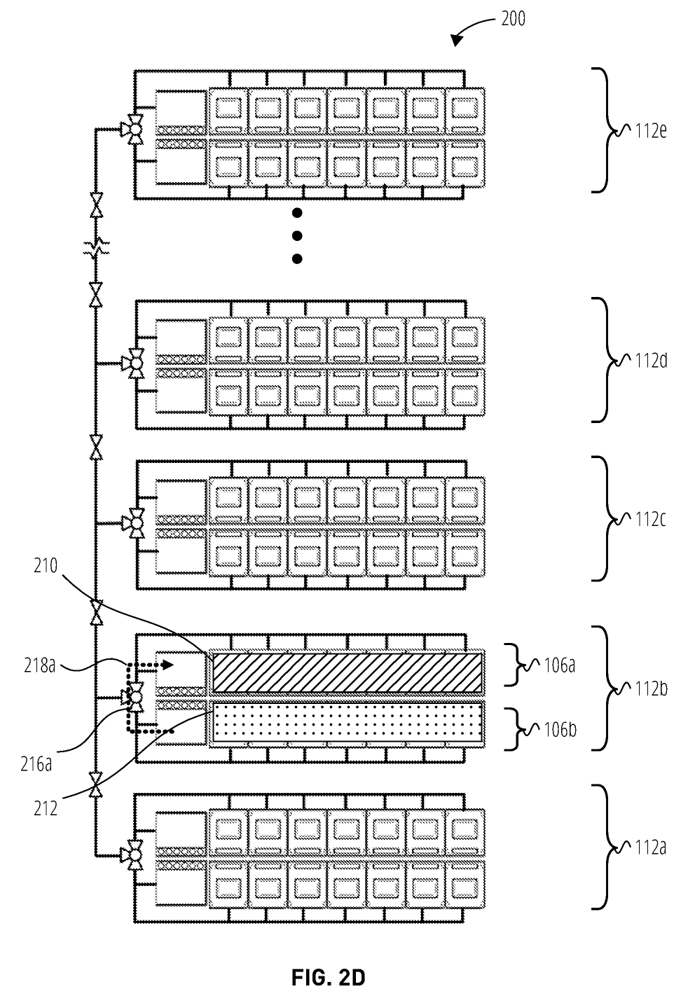

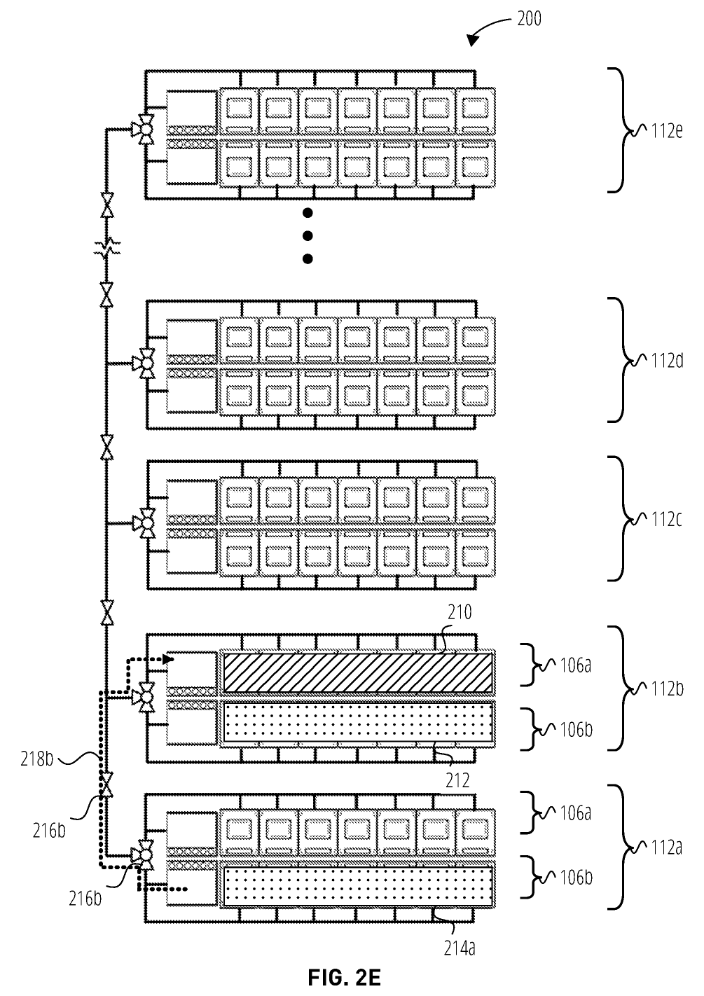

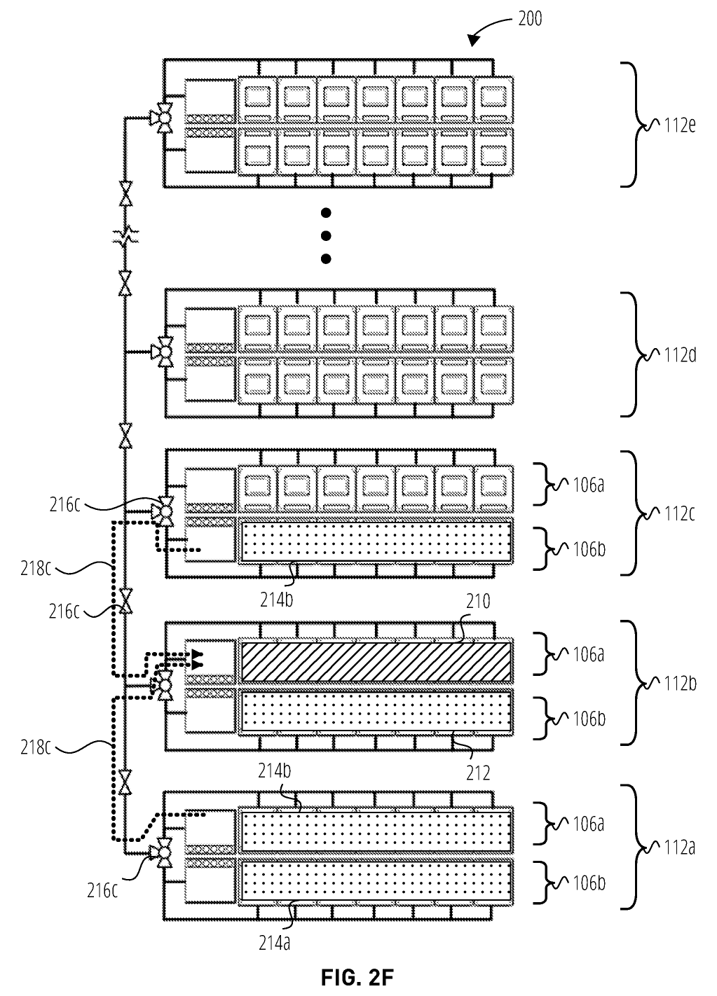

FIG. 2A illustrates an example of liquid-cooled data center 200 that includes multiple cells (i.e., cell 112a, cell 112b, cell 112c, cell 112d, and cell 112e). Each row in a given cell is connected to at least one other row in the cell using one or more intra-cell valves 114. In the illustrated example, the cells are shown with each cell including two rows, but more than two rows can be included per cell and the number of rows can be different for different cells.

Further, for simplicity, only a single set of tubing is shown for each row. The shown tubing is for cold line 108. In cases where the cooling is not a closed loop (e.g., the CDUs draw water from and return water to a common reservoir), hot line 110 can simply be a line going back to the reservoir. For cases including valves on both cold line 108 and hot line 110, the valve configuration for the hot line can be the same as for the cold line. Alternatively, the valve configuration on the hot line can be different than the cold line. For example, as discussed above, cold line 108 can use two valves that are three-way valves, as shown in FIG. 1D, and hot line 110 can use a single valve that is a two-way valve, as shown in FIG. 1C.

FIG. 2B illustrates an example of liquid-cooled data center 200 that further includes inter-cell valves 208 and tubing connecting respective cells. Controller 202 provides control signals 204 that cause the respective valves to open or close. Controller 202 can communicate with the CDUs and/or receive sensor measurements and other feedback from the rows to determine if any of the CDUs fails, is operating with diminished capacity, or otherwise is insufficient to cool the equipment in its row. When such a failing row is determined, controller 202 causes a subset of valves to open or close to divert some of the coolant from neighboring rows to the failing row, which causes the excess cooling capacity from neighboring rows to compensate for the cooling deficit of the failing row.

Depending on how large the cooling deficit is and how much excess cooling capacity is latent in the neighboring rows, the subset of neighboring rows used to compensate for the cooling deficiency may be small (e.g., contained within a single cell) or large (e.g., extending across multiple cells). When the subset of compensating rows (i.e., the set of rows that have been selected to contribute some or all of their excess cooling capacity to compensate for the cooling deficit in the failing row) extends across multiple cells, controller 202 will cause both intra-cell valves and inter-cell valves to open thereby providing fluid communication between the rows in two or more cells. For example, when a cell lacks sufficient excess cooling capacity to compensate for a failing row within the cell, controller 202 can expand the subset of compensating rows to include one or more rows from neighboring cells. The subset of compensating rows continues to be expanded until controller 202 determines that the combined excess cooling capacity of the subset of compensating rows is sufficient to compensate for the cooling deficit of the failing row. When the subset of compensating rows includes more than one cell, one or more inter-cell valves are opened to connect the cells that include the failing row to the subset of compensating rows.

According to certain non-limiting examples, when there is sufficient excess cooling capacity in the cell that includes the failing row, controller 202 can satisfy the cooling deficit using only the other rows in the cell. This can be achieved by opening one or more intra-cell valves 114 within the cell to divert coolant to the failing row from the other rows in the cell. This can be performed as discussed above for FIG. 1C.

According to certain non-limiting examples, controller 202 can communicate with the CDUs in the respective rows to determine how much excess cooling capacity there is in the respective rows and to determine a cooling deficit of the failing row. Controller 202 determines a subset of neighboring rows in the cell that have a combined excess cooling capacity sufficient to satisfy the cooling deficit of the failing row. Controller 202 can open the intra-cell valves between the failing row and the determined subset of neighboring rows. Further, the percentage of coolant flowing to the failing row from the respective CDUs in the other rows will depend on the relative coolant pressure at the outputs of the CDUs and will depend on the fluid resistance (e.g., the degree to which the intra-cell valves are open) between the outputs of the CDUs and the failing row. Thus, controller 202 can control how much excess cooling capacity is diverted from the other rows to the failing row by controlling the pumping rate (e.g., coolant pressure) of each of the CDUs and/or by controlling the size of the open apertures of the valves in the path of the coolant.

According to certain non-limiting examples, controller 202 can receive feedback representing sensor measurements from the rows in the cell, and controller 202 can determine which intra-cell valves to open and or the pumping rates for the CDUs based on the sensor measurements. For example, a temperature sensor (e.g., thermistor or thermocouple) in a row can be used to indicate that the row is failing. Controller 202 can open the intra-cell valves between the failing row and the nearest-neighbor rows. Further, controller 202 can increase the cooling contributions from the nearest-neighbor rows by instructing the CDUs in the nearest-neighbor rows to pump faster, and controller 202 can decrease or stop the cooling contributions from the failing row by instructing the valve in the failing row to slow or stop coolant flow from the CDU in the failing row. Additionally or alternatively, controller 202 can decrease or stop the cooling contributions from the failing row by instructing the CDU in the failing row to pump slower or to cease pumping. Controller 202 can use a PID feedback control loop that uses the sensor measurements in a control loop to adjust the cooling contributions of the respective CDUs to the failing row until the sensor measurements indicate that the failing row is operating within the desired parameters (e.g., within the required temperature range). For example, the desired parameters can include a temperature range for the equipment in the racks, a temperature range for the coolant in cold line 108, a temperature range for the coolant in hot line 110, a flow rate for the coolant, etc.

When the excess cooling capacity of the nearest-neighbor rows is insufficient to make up for the cooling deficit in the failing row, controller 202 can expand the number of rows that are contributing their excess cooling capacity to the failing row. For example, the intra-cell valves can be opened between the failing row and the next-nearest-neighboring rows (i.e., rows that are separated from the failing row by two links/intra-cell valves). Thus, the contributing rows will include both nearest-neighboring rows (i.e., one link away from the failing row) and next-nearest-neighboring rows (i.e., two links away from the failing row).

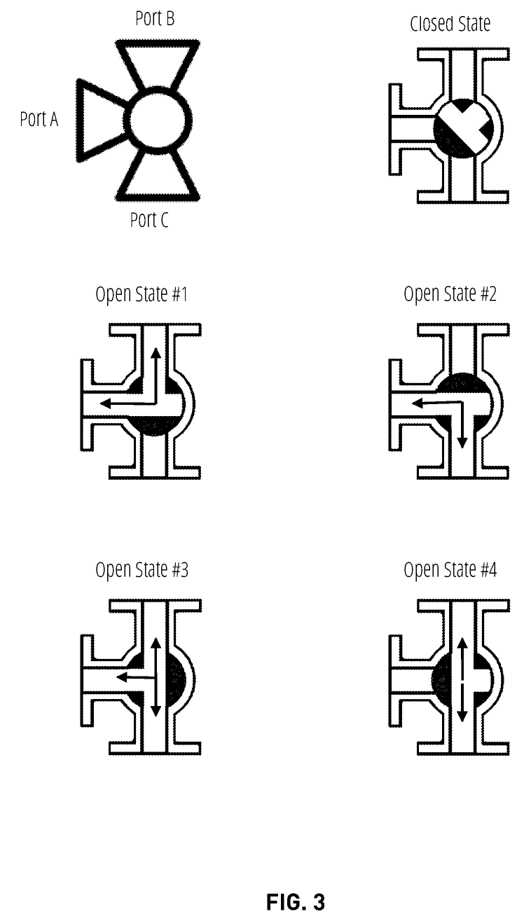

When the excess cooling capacity of the rows in the cell is insufficient to compensate for the cooling deficit in the failing row, controller 202 can expand the number of rows in the subset of compensating rows to include rows from one or more neighboring cells. The above-discussed single-cell techniques for determining how many and which rows to include in the subset of compensating rows can also be applied when expanding the subset of compensating rows to include multiple cells. When expanding the subset of compensating rows to include multiple cells, controller 202 will open both intra-cell valves 114 and inter-cell valves 208 between the failing row and the subset of compensating rows to realize the desired coolant flow to the failing row. For example, a subset of compensating rows that includes both cell 112a and cell 112b would require opening intra-cell valve 114 of cell 112a, intra-cell valve 114 of cell 112b, and inter-cell valve 208 between cell 112a and cell 112b. When intra-cell valve 114 is a three-way valve, the valve can be opened to provide fluid communication to either or both of the rows in a given cell. The possible states of a three-way valve (e.g., one closed state and four open states) are discussed below with reference to FIG. 3.

FIG. 2C illustrates feedback signals that are received from the rows and cells. For example, CDUs 104 can communicate to controller 202 their pump rates, temperatures within the CDU, the temperature of the coolant at an inlet port of CDU 104 (e.g., the temperature of the coolant from hot line 110), and/or the temperature of the coolant at an outlet port of CDU 104 (e.g., the temperature of the coolant flowing to cold line 108). Further, CDUs 104 can communicate their cooling capacity, how much of that cooling capacity is currently being used, fault messages or other indicators of the state of functioning of the CDU.

According to certain non-limiting examples, feedback signals 206 from the rows to controller 202 can include measurements from sensors outside of the CDUs. These sensor measurements from sensors outside of the CDUs can include flow rates for the coolant at various points along the tubing, temperatures of the coolant at various points along the tubing, signals from the IT equipment, etc.

Cooling logic can be applied to determine if a row is failing. For example, a row can be determined to be failing when the CDU on that row is operating at diminished capacity or is otherwise not capable of satisfying the cooling requirements of the IT equipment on that row. Cooling logic can be applied to determine how much excess cooling capacity is available in neighboring rows (e.g., in the same cell or adjacent cells) that can be diverted to the failing row to compensate for the cooling capacity deficit in the failing row. In addition to selecting which neighboring rows are used to supplement the cooling in the failing row, controller 202 can determine the operating parameters of the CDUs 104 and the valve configurations (both intra-cell valves 114 and inter-cell valves 208) that are used to apply the excess cooling capacity form the supplementing rows to the failing row.

According to certain non-limiting examples, this determination can be based on a feedback loop and PID control logic or other control logic. According to certain non-limiting examples, a safety margin can be applied to the amount of excess cooling capacity to can be diverted from the supplementing rows, which avoids overcommitting the excess cooling capacity from the supplementing rows.

FIG. 2D illustrates an example in which upper row 106a of cell 112b is failing row 210. In this example, the excess cooling capacity of lower row 106b of cell 112b can be sufficient to satisfy the cooling capacity deficit of failing row 210. Thus, controller 202 selects lower row 106b of cell 112b as supplementing row 212. Controller 202 opens intra-cell valve 114 in cell 112b, which becomes open valve 216a. Open valve 216a can be in open state #4 shown in FIG. 3 to allow coolant to flow from supplementing row 212 to failing row 210. Further, to cause coolant flow 218a from supplementing row 212 to failing row 210, controller 202 can cause the pumping rates for the respective CDUs in upper row 106a and lower row 106b of cell 112b to generate a pressure differential between the rows within cell 112b that causes coolant flow 218a to have the desired flow rate.

If the cooling capacity deficit in failing row 210 becomes larger than the excess cooling capacity of supplementing row 212, controller 202 can increase the number of rows contributing to removing heat from failing row 210 by selecting additional supplementing rows to help offset the cooling capacity deficit in failing row 210.

FIG. 2E illustrates an example in which controller 202 selects lower row 106b of cell 112a as additional supplementing row 214a. To use coolant from additional supplementing row 214a to cool failing row 210, controller 202 identifies two additional valves as open valves 216b (i.e., intra-cell valve 114 of cell 112a and inter-cell valve 208 between cell 112a and cell 112b). For example, controller 202 causes intra-cell valve 114 in cell 112a to open in open state #2, shown in FIG. 3. Further, controller 202 causes intra-cell valve 114 in cell 112b to open in open state #3, shown in FIG. 3. Additionally, controller 202 can instruct the CDU in additional supplementing row 214a to operate at a pumping rate that results in the desired flow rate for coolant flow 218b.

If the supplemental cooling is still insufficient to offset the cooling capacity deficit in failing row 210, controller 202 can further increase the number of rows contributing to removing heat from failing row 210.

FIG. 2F illustrates an example in which controller 202 selects upper row 106a of cell 112a and lower row 106b of cell 112a as additional supplementing row 214b. To use coolant from additional supplementing row 214b to cool failing row 210, controller 202 identifies two additional valves as open valves open valves 216c (i.e., intra-cell valve 114 of cell 112c and inter-cell valve 208 between cell 112b and cell 112c). For example, controller 202 causes intra-cell valve 114 in cell 112c to open in open state #2, and controller 202 causes intra-cell valve 114 in cell 112c to open in open state #3. Additionally, controller 202 can instruct the CDUs corresponding to supplementing row 212, additional supplementing row 214a, and additional supplementing row 214b to operate at pumping rates that result in the desired flow rates for coolant flow 218a, coolant flow 218b, and coolant flow 218c.

If the supplemental cooling is still not sufficient to offset the cooling capacity deficit in failing row 210, controller 202 can further increase the number of rows contributing to remove heat from 210. Alternatively, controller 202 may determine that there is not sufficient excess cooling capacity within the set of all possible supplementing rows. In response to this determination, controller 202 can isolate or quarantine the failure in failing row 210 by closing intra-cell valve 114 in cell 112b. To avoid damage to the IT equipment, the IT equipment in failing row 210 can be powered down until the CDU in failing row 210 is repaired. Thus, controller 202 can minimize the impact of failing row 210 to the surrounding rows and the operations of the data center.

FIG. 3 illustrates an example of a three-way valve, which has three ports (i.e., port A, port B, and port C). The three-way valve is illustrated as having five states: one closed state and four open states. In the closed state, the three-way valve prevents fluid communication (e.g., flow) between the ports. In open state #1, the three-way valve allows fluid communication between port A and port B. In open state #2, the three-way valve allows fluid communication between port A and port C. In open state #3, the three-way valve allows fluid communication among all three ports. In open state #4, the three-way valve allows fluid communication between port B and port C.

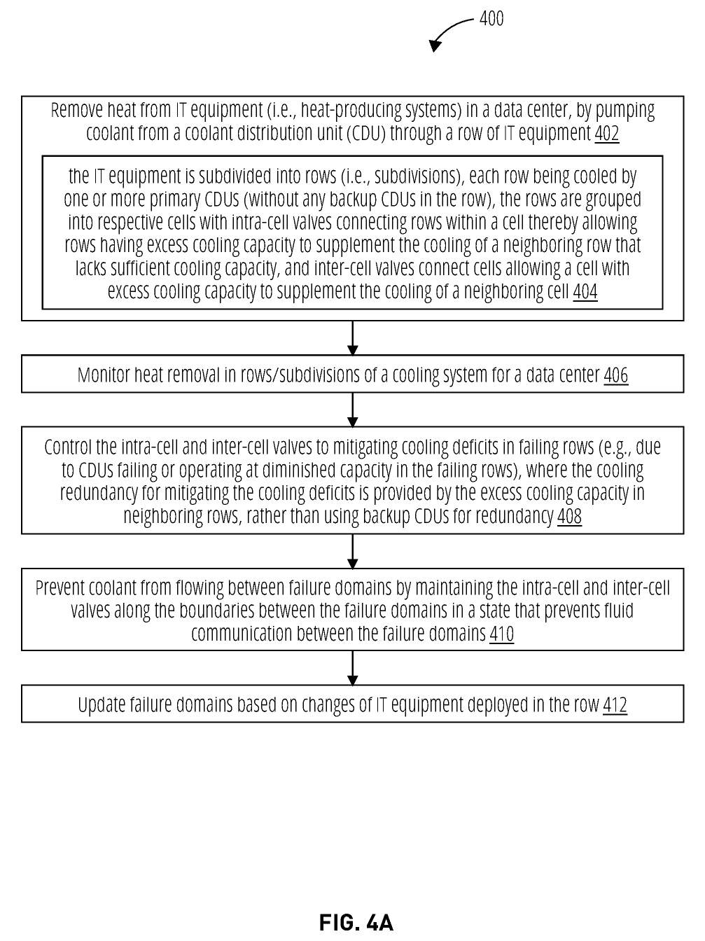

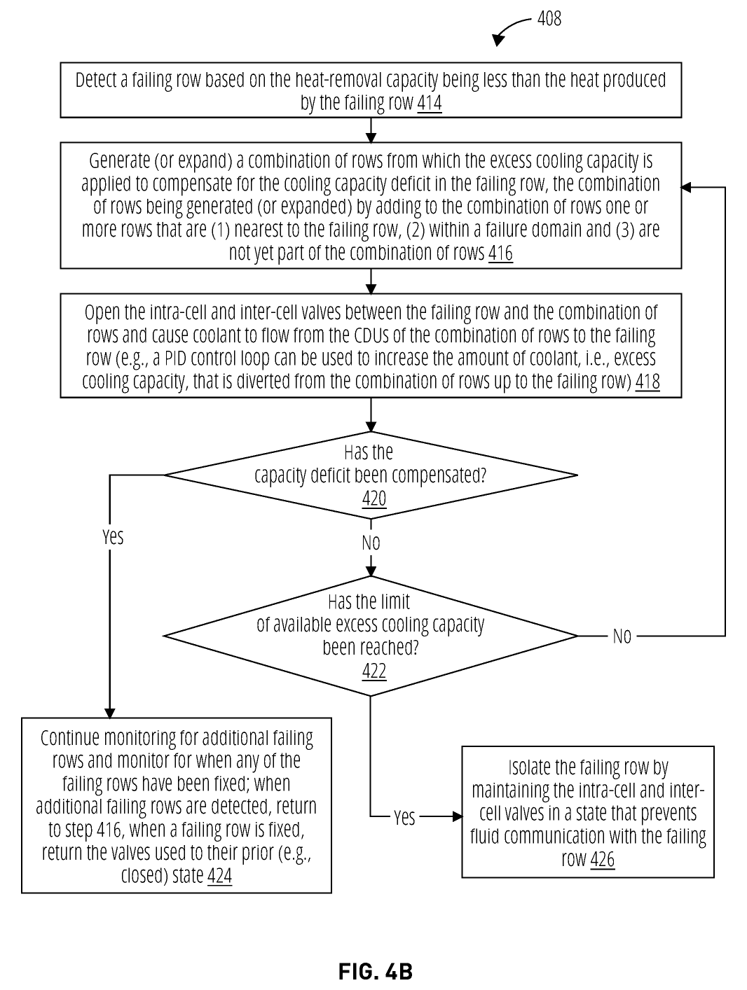

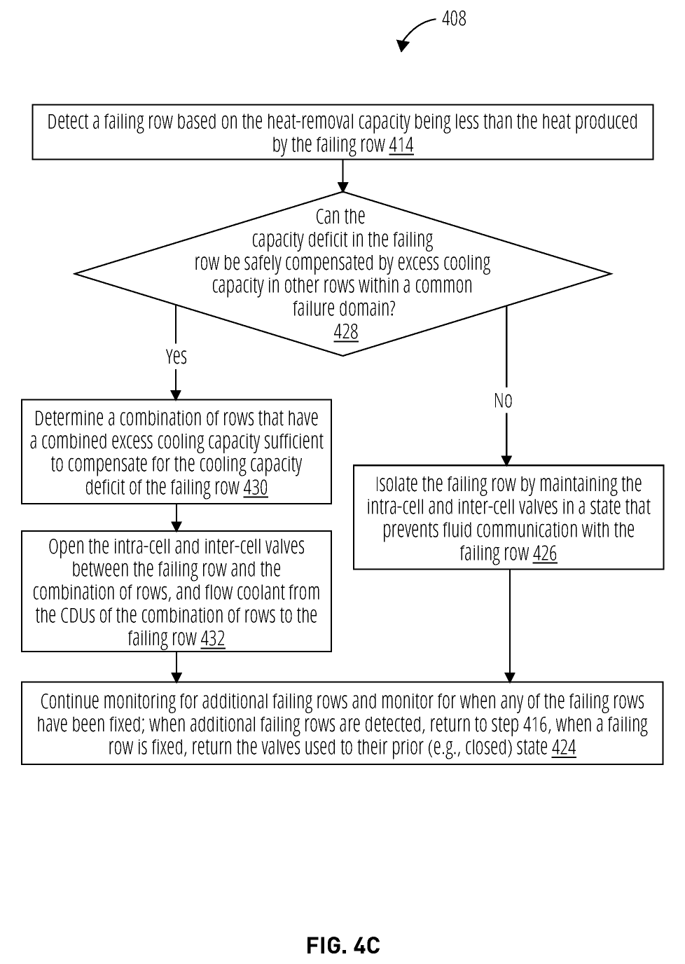

FIG. 4A illustrates an example method 400 for compensating cooling failures in a row of a cooling system using the excess cooling capacity in one or more neighboring rows, rather than using a backup/contingency CDU in the row. Although the example method 400 depicts a particular sequence of operations, the sequence may be altered without departing from the scope of the present disclosure. For example, some of the operations depicted may be performed in parallel or in a different sequence that does not materially affect the function of method 400. In other examples, different components of an example device or system that implements method 400 may perform functions at substantially the same time or in a specific sequence.

According to some examples, step 402 of the method includes removing heat from IT equipment (i.e., heat-producing systems) in a data center by pumping coolant from a coolant distribution unit (CDU) through a row of IT equipment. For example, liquid-cooled data center 200 illustrated in FIG. 2A may remove heat from IT equipment (i.e., heat-producing systems) in a data center by pumping coolant from a coolant distribution unit (CDU) through a row of IT equipment.

According to some examples, step 402 can include block 404. As described in block 404, the IT equipment is subdivided into rows (i.e., subdivisions), and each row is cooled by one or more primary CDUs (without any backup CDUs in the row). The rows are grouped into respective cells. The intra-cell valves connect rows within a cell, thereby allowing rows having excess cooling capacity to supplement the cooling of a neighboring row that lacks sufficient cooling capacity. The inter-cell valves connect cells to other cells allowing a cell with excess cooling capacity to supplement the cooling of a neighboring cell that lacks sufficient cooling capacity.

For example, in the liquid-cooled data center 200 illustrated in FIG. 2A, the IT equipment can be subdivided into rows (i.e., subdivisions), with each row (e.g., upper row 106a and lower row 106b) being cooled by one or more primary CDUs 104 (without any backup CDUs in the row). The rows are grouped into respective cells (e.g., cell 112a through cell 112e) with intra-cell valves 114 connecting rows within a cell, thereby allowing rows having excess cooling capacity to supplement the cooling of a neighboring row that lacks sufficient cooling capacity. Similarly, inter-cell valves 208 can connect respective cells allowing a cell with excess cooling capacity to supplement the cooling of a neighboring cell.

Each row (i.e., subdivision) includes a heat-producing system (e.g., IT equipment and servers) that produces heat and a heat-dissipating system (e.g., CDU 104), which provides a heat-removal capacity. Further, each row includes tubing that conveys the coolant from the heat-dissipating system to the heat-producing system. For example, a first intra-cell valve can be located between a first row/subdivision and a second row/subdivision of a cell. When in an open state, the first intra-cell valve provides fluid communication between the first row/subdivision and the second row/subdivision. When in a closed state, the first intra-cell valve prevents fluid communication between the first row/subdivision and the second row/subdivision, When the first row/subdivision lacks sufficient cooling capacity (i.e., has a cooling capacity deficit), controller 202 can cause the first intra-cell valve to be in an open state, and a pressure differential causes coolant to flow from the heat-dissipating system of the second subdivision to the heat-producing system of the first row/subdivision, thereby applying an excess cooling capacity of the second row/subdivision to remove heat from the first row/subdivision.

The excess cooling capacity of a row/subdivision is the difference between the heat-removal capacity of the heat-dissipating system and the heat produced by the heat-producing system of the row/subdivision. The cooling capacity deficit of a row/subdivision is the difference between the heat produced by the heat-producing system and the heat-removal capacity of the heat-dissipating system of the row/subdivision.

According to some examples, step 406 of the method includes monitoring heat removal in rows/subdivisions of a cooling system for a data center. For example, controller 202 illustrated in FIG. 2B may monitor heat removal in rows/subdivisions of a cooling system for a data center.

According to certain non-limiting examples, controller 202 can provide control signals 204 that cause the respective valves to open or close. Further, control signals 204 can instruct the rows/subdivisions to create pressure differentials that cause coolant to flow between rows that are connected through opened valves.

Further, controller 202 can receive feedback signals 206 indicating the performance of the cooling loops in the respective rows. For example, feedback signals 206 can include temperature and flow rate measurements at various points within the cooling system. According to certain non-limiting examples, feedback signals 206 can be received when controller 202 communicates with the CDUs and/or receives sensor measurements and other feedback from the rows. Feedback signals 206 are used by controller 202 to determine if any of the CDUs has failed, is operating with a diminished capacity, or is otherwise not capable of cooling the IT equipment in its row.

Additionally or alternatively, controller 202 can use a PID control loop or another control loop using feedback representing sensor measurements from the rows in the cell. Controller 202 can determine which intra-cell valves to open and or pumping rates for the CDUs based on feedback in the form of sensor measurements. For example, a temperature sensor (e.g., thermistor or thermocouple) in a row can be used to indicate whether cooling in the row is failing.

According to some examples, process 408 of the method includes controlling the intra-cell and inter-cell valves to mitigate cooling deficits in one or more failing rows. As discussed above, the cooling deficits can be due to CDUs in the failing rows failing or operating at diminished capacity. The cooling redundancy that is used for mitigating the cooling deficits is provided by the excess cooling capacity in neighboring rows, rather than using backup CDUs for the cooling redundancy.

According to some examples, step 410 of the method includes preventing coolant from flowing between failure domains within the cooling system by maintaining the intra-cell and inter-cell valves along the boundaries between the failure domains in a state that prevents fluid communication between the failure domains (e.g., a closed state). For example, a subset of intra-cell valves 114 that are along a failure-domain boundary can be maintained in a closed state to prevent coolant from flowing between failure domains. Further, controller 202 can maintain inter-cell valves 208 that are along the failure-domain boundary in a closed state to prevent coolant from flowing between failure domains. By maintaining the intra-cell and inter-cell valves along the boundaries between the failure domains in the closed state, fluid communication between the failure domains is prevented, thereby isolating each failure domain from the other failure domains.

According to some examples, step 412 of the method includes updating failure domains based on changes to the IT equipment that is deployed in the respective rows. For example, the controller 202 illustrated in FIG. 2B may update failure domains based on changes to the IT equipment deployed in the row.

FIG. 4B illustrates an example of process 408 for controlling the intra-cell and inter-cell valves to compensate for cooling deficits in a failing row. Although the example method 400 depicts a particular sequence of operations, the sequence may be altered without departing from the scope of the present disclosure. For example, some of the operations depicted may be performed in parallel or in a different sequence that does not materially affect the function of process 408. In other examples, different components of an example device or system that implements process 408 may perform functions at substantially the same time or in a specific sequence.

According to some examples, step 414 of process 408 includes detecting a failing row based on the heat-removal capacity of a row being less than the heat produced in said row. For example, controller 202 illustrated in FIG. 2B may detect a failing row based on the heat-removal capacity being less than the heat produced by the failing row.

According to some examples, step 416 of process 408 includes generating (or expanding) a combination of rows from which the excess cooling capacity is extracted to compensate for the cooling capacity deficit in the failing row. According to certain non-limiting examples, the combination of rows can be generated (or expanded) by adding to the combination of one or more rows that are (1) nearest to the failing row, (2) within a failure domain and (3) are not yet part of the combination of rows.

For example, controller 202 illustrated in FIG. 2B may generate (or expand) the combination of rows from which the excess cooling capacity is extracted and used to compensate for the cooling capacity deficit in the failing row. Controller 202 can generate (or expand) the combination of rows by adding to the combination of rows one or more rows that are (1) nearest to the failing row, (2) within a failure domain, and (3) are not yet part of the combination of rows.

According to some examples, step 418 of process 408 includes opening the intra-cell and inter-cell valves between the failing row and the combination of rows and causing coolant from the CDUs in the combination of rows to flow to the failing row. According to certain non-limiting examples, a PID control loop can be used to increase the amount of coolant (i.e., excess cooling capacity) that is diverted from the combination of rows up to the failing row. The amount of coolant diverted from respective rows in the combination of rows can be limited to the excess cooling capacity of the respective rows minus a safety margin that ensures the diverted coolant does not adversely affect the respective rows (e.g., by leaving insufficient cooling capacity to cool the IT equipment in the respective rows).

For example, controller 202 may send instructions to open intra-cell valve 114 and inter-cell valves 208 which are between the failing row and the combination of rows. Further, controller 202 may send instructions causing a pressure gradient that causes the coolant to flow from the CDUs in the combination of rows towards the IT equipment in the failing row. For example, PID a control loop can be used to increase the amount of excess cooling capacity transferred from the combination of rows up to a predefined limit. The predefined limit can provide a safety margin to ensure that the diverted cooling capacity does not adversely affect cooling in the combination of rows.

According to some examples, decision step 420 inquires whether the cooling capacity deficit been compensated by the excess cooling capacity of the combination of rows. When the cooling capacity deficit has not been compensated, process 408 continues from decision step 420 to decision step 422. When the cooling capacity deficit has been compensated, process 408 continues from decision step 420 to step 424. That is, the cooling capacity deficit of the failing row has been addressed, and the cooling system continues to monitor for additional changes. For example, controller 202 illustrated in FIG. 2B may inquire whether the cooling capacity deficit has been compensated by the excess cooling capacity of the combination of rows.

According to some examples, decision step 422 of process 408 inquires whether the maximum for the excess cooling capacity has been reached. For example, when all rows having excess cooling capacity within a failure domain have been included in the combination of rows that is used for cooling the failing row, then there is no more excess cooling capacity that is available within the failure domain. If the maximum for the excess cooling capacity has not been reached, process 408 continues from decision step 422 to step 416. If the maximum for the excess cooling capacity has been reached, process 408 continues from decision step 422 to step 426.

According to some examples, step 424 of process 408 includes monitoring for additional changes. For example, step 424 can include continuing to monitor the cooling system to detect any additional failing rows. When additional failing rows are detected, process 408 can return to step 416 to address the additional failing rows. Step 424 can also include monitoring the cooling system to detect when any of the failing rows have been fixed. For example, the failing row can be fixed when the CDU in the failing row has been repaired and has returned to operating at full cooling capacity such that there is no longer a cooling capacity deficit). When the failing row is fixed, the open valves that were used to compensate for the cooling capacity deficit can be returned to their default state (e.g., the closed state). For example, CDU 104 illustrated in FIG. 1A can signal to controller 202 that the CDU has returned to full functionality, and in response controller 202 can return the open valves to their closed state (i.e., return the cooling system to its normal operation configuration when there are no failing rows).

According to some examples, step 426 of process 408 includes isolating the failing row by maintaining the intra-cell and inter-cell valves in a state that prevents fluid communication with the failing row. For example, controller 202 can signal to intra-cell valve 114 and inter-cell valve 208 to isolate the failing row by maintaining the intra-cell valves 114 and inter-cell valves 506 adjacent to the failing row to return and stay in the closed state.

FIG. 4C illustrates another example of process 408 for controlling the intra-cell and inter-cell valves to compensate for cooling deficits in a failing row. Although the example method 400 depicts a particular sequence of operations, the sequence may be altered without departing from the scope of the present disclosure. For example, some of the operations depicted may be performed in parallel or in a different sequence that does not materially affect the function of process 408. In other examples, different components of an example device or system that implements process 408 may perform functions at substantially the same time or in a specific sequence.

According to some examples, the method includes detecting a failing row based on the heat-removal capacity being less than the heat produced by the failing row at step 414. For example, controller 202 illustrated in FIG. 2B may detect a failing row based on the heat-removal capacity being less than the heat produced by the failing row.

According to some examples, decision step 428 of process 408 inquires whether the cooling capacity deficit in the failing row can be safely compensated by the excess cooling capacity in other rows within a common failure domain. When the cooling capacity deficit in the failing row can be safely compensated by the available excess cooling capacity, process 408 continues from decision step decision step 428 to step 430. When the cooling capacity deficit cannot be safely compensated by the available excess cooling capacity, process 408 continues from decision step 428 to step 430.

According to some examples, step 430 of process 408 includes determining a combination of rows that have a combined excess cooling capacity sufficient to compensate for the cooling capacity deficit of the failing row. For example, the controller 202 illustrated in FIG. 2B may determine a combination of rows that have a combined excess cooling capacity sufficient to compensate for the cooling capacity deficit of the failing row.

According to some examples, step 432 of process 408 includes opening the intra-cell and inter-cell valves between the failing row and the combination of rows and causing coolant from the CDUs in the combination of rows to flow to the failing row. For example, controller 202 may send instructions to open intra-cell valve 114 and inter-cell valves 208 which are between the failing row and the combination of rows. Further, controller 202 may send instructions causing a pressure gradient that causes the coolant to flow from the CDUs in the combination of rows towards the IT equipment in the failing row. A safety margin can be applied such that a certain amount or percentage of the excess cooling capacity is kept at the rows of the combination of rows. The safety margin can ensure that the diverted cooling capacity does not adversely affect cooling in the combination of rows, such as when the rows experience variations in the heat produced by the IT equipment or variations in the ambient temperature in the data center.

According to some examples, step 424 of process 408 includes monitoring for additional changes. For example, step 424 can include continuing to monitor the cooling system to detect any additional failing rows. When additional failing rows are detected, process 408 can return to step 416 to address the additional failing rows. Step 424 can also include monitoring the cooling system to detect when any of the failing rows have been fixed. For example, the failing row can be fixed when the CDU in the failing row has been repaired and has returned to operating at full cooling capacity such that there is no longer a cooling capacity deficit). When the failing row is fixed, the open valves that were used to compensate for the cooling capacity deficit can be returned to their default state (e.g., the closed state). For example, CDU 104 illustrated in FIG. 1A can signal to controller 202 that the CDU has returned to full functionality, and in response controller 202 can return the open valves to their closed state (i.e., return the cooling system to its normal operation configuration when there are no failing rows).

According to some examples, step 426 of process 408 includes isolating the failing row by maintaining the intra-cell and inter-cell valves in a state that prevents fluid communication with the failing row. For example, controller 202 can signal to intra-cell valve 114 and inter-cell valve 208 to isolate the failing row by maintaining the intra-cell valves 114 and inter-cell valves 506 adjacent to the failing row to return and stay in the closed state.

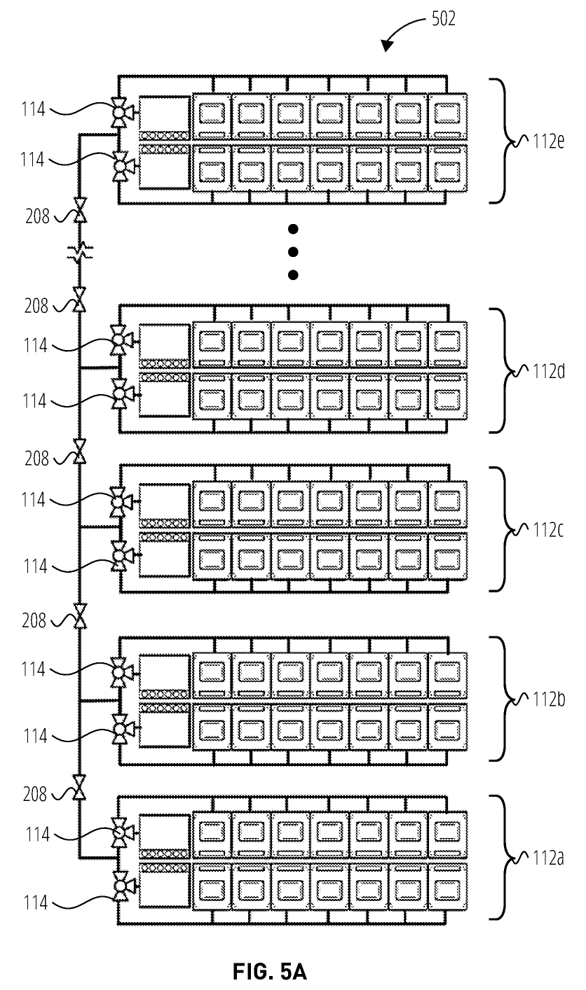

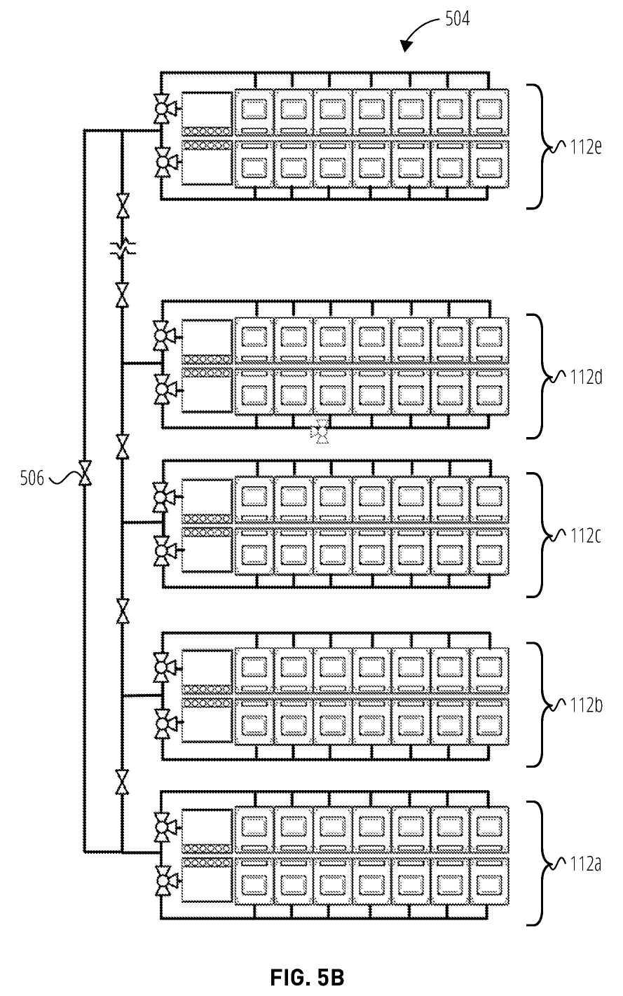

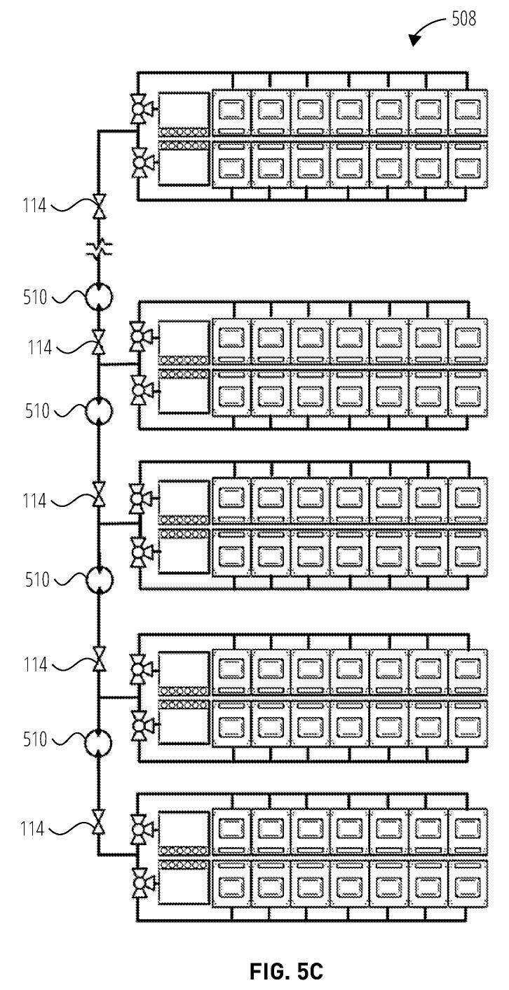

FIG. 5A illustrates another non-limiting configuration of a liquid-cooled data center. In configuration 502, each cell includes two rows, and each row has a three-way valve. The three-way valves can be T-type values, allowing various combinations of pathways and mixing for the fluid flow, as illustrated in FIG. 3. Using T-type valves enables combining fluids from separate sources and splitting a single flow into two separate flows. For example, coolant can enter ports A and B and exit through port C, or coolant can enter through port C and exit through ports A and B. Additionally, the T-type valve can be set to provide fluid communication through any of the possible pairs of ports (e.g., ports A and B, ports A and C, or ports B and C). Configuration 502 provides flexibility for providing fluid communication between various portions of tubing.

FIG. 5B illustrates a third non-limiting configuration of a liquid-cooled data center. In configuration 504, inter-cell valve 506 is provided between cell 112a and cell 112e. This is a ring topology in which each cell is nearest neighbor to exactly two other cells (e.g., there are no edge cells that are connected to only one other cell). The relation between a given cell and a neighboring cell (i.e., whether the given cell and the neighboring cell are nearest neighbors (one link), next-nearest neighbors (two links), next-next-nearest neighbors (three links), and so forth) is based on the number of links between the given cell and the neighboring cell (e.g., the lowest number of inter-cell valves 208 for a path between the given cell and the neighboring cell).

FIG. 5C illustrates a fourth non-limiting configuration of a liquid-cooled data center. In configuration 508, inter-cell pumps 510 are provided between cells. For example, inter-cell pumps 510 can be bidirectional pumps that are used by controller 202 to control the flow of coolant among the cells. In the absence of inter-cell pumps 510, the direction of flow between two cells is determined by the relative fluid pressures of the coolant at the outputs of the cells (e.g., at the coolant outlet of a CDU). When the cells have the same pressure no coolant will flow from one cell to the other, even though inter-cell valve 208 between the cells is open. The relative pressure between the cells can be affected by increasing or decreasing the amount of pumping within the CDU. Additionally or alternatively, inter-cell pump 510 can be used to dictate the flow of coolant between cells.

FIG. 6A illustrates a fifth non-limiting configuration of a liquid-cooled data center. In square-grid configuration 602, the cells are arranged in layers (e.g., layer 604a, layer 604b, and layer 604c). In this case, cells within a layer are connected by inter-cell valves 208 to the neighboring cells, and the cells are connected by inter-cell valves 208 to the neighboring cells in adjacent layers. This is a square-grid topology for the cells.

FIG. 6B shows another view of the square-grid topology for the cells, wherein each vertex represents a cell. Each line between vertices represents tubing that connects the cells (vertices), and an inter-cell valve 208 is provided in the tubing between cells. For interior cells (i.e., cells not on the boundary of the grid), each cell has four nearest neighbors (i.e., four cells that are one link away).

A square-grid topology can also be used for connections between rows within a given cell. In this case, each vertex would correspond to a row, and the lines connecting rows can correspond to tubing and intra-cell valves 114 between rows.

FIG. 6C shows an example of partitioning square-grid configuration 602 into three failure domains (e.g., failure domain 606a, failure domain 606b, and failure domain 606c), which are separated by failure-domain boundaries (e.g., failure-domain boundary 608a and failure-domain boundary 608b). The failure domains can reduce risk to a data center by ensuring that a failure in one failure domain does not adversely affect another failure domain. The choice of how large to make the failure domains and which rows and cells are grouped together in the failure domains can be informed by the types of IT equipment, the function/purpose of the IT equipment, the criticality/sensitivity of the IT equipment, the resilience of the IT equipment to temperature spikes and/or fluctuations, and the dependencies among the various pieces of IT equipment. Accordingly, when there are changes in the data center (e.g., new IT equipment is installed or the services provided by the data center evolve) the arrangement of the failure domains can be adjusted to account for these changes.

According to certain non-limiting examples, controller 202 preserves the integrity of the failure domains by maintaining the valves along the failure-domain boundaries in a closed state to prevent fluid communication between the failure domains. As discussed above, the vertices in square-grid configuration 602 can represent either rows or cells, which include multiple rows.

FIG. 6D shows an example of partitioning square-grid configuration 602 into four failure domains (e.g., failure domain 606a, failure domain 606b, failure domain 606c, and failure domain 606d), which are separated by failure-domain boundaries (e.g., failure-domain boundary 608a and failure-domain boundary 608b). As in FIG. 6C, controller 202 preserves the integrity of the failure domains by maintaining the valves along the failure-domain boundaries in a closed state to prevent fluid communication between the failure domains.

FIG. 6E shows an example of partitioning liquid-cooled data center 200 into three failure domains (e.g., failure domain 606a, failure domain 606b, and failure domain 606c), which are separated by failure-domain boundaries (e.g., failure-domain boundary 608a and failure-domain boundary 608b). Here, controller 202 preserves the integrity of the failure domains by maintaining the inter-cell valves 208 along the failure-domain boundaries in a closed state to prevent fluid communication between the failure domains.

FIG. 7A, FIG. 7B, and FIG. 7C illustrate examples of additional topologies that can be used for inter-cell valves 208 connecting cells. In each of these examples, the vertices represent the cells and the lines between vertices represent the tubing and inter-cell valves 208 connecting respective cells. As stated above, these topologies can also be used for rows within a cell, wherein the vertices represent the cells and the lines represent intra-cell valves 114 between cells.

These topologies represent the connections between cells (or rows), but they do not necessarily represent the physical locations of the cells (or rows). For example, the cells (or rows) for the square-grid topology can be on the same floor of a data center. More generally, the number of cells (or rows in a cell) and the arrangement among them (i.e., which cells are nearest neighbors to which other cells) can be determined on an ad hoc basis, without any discernable pattern.

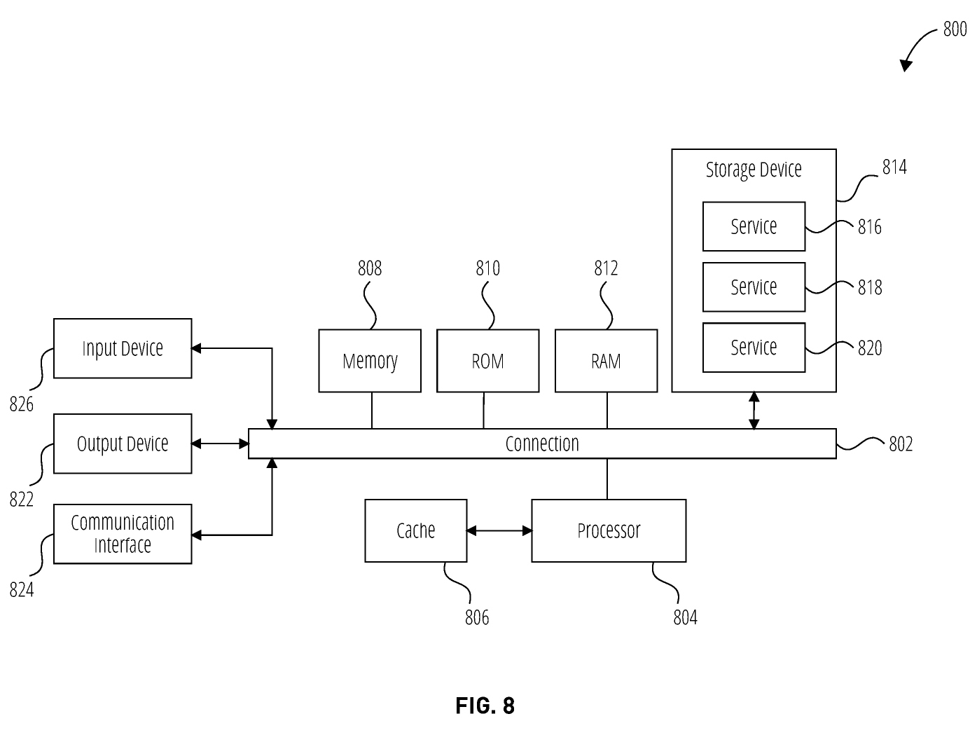

FIG. 8 shows an example of computing system 800, which can be, For example, any computing device making up any controller 202 illustrated in FIG. 2B or any component thereof in which the components of the system are in communication with each other using connection 802. Computing system 800 can implement method 400. Connection 802 can be a physical connection via a bus, or a direct connection into processor 804, such as in a chipset architecture. Connection 802 can also be a virtual connection, networked connection, or logical connection.

In some embodiments, computing system 800 is a distributed system in which the functions described in this disclosure can be distributed within a data center, multiple data centers, a peer network, etc. In some embodiments, one or more of the described system components represents many such components each performing some or all of the function for which the component is described. In some embodiments, the components can be physical or virtual devices.

For example, computing system 800 can include at least one processing unit (e.g., processor 804) and connection 802 that couples various system components including system memory 808, such as read-only memory (e.g., ROM 810) and random access memory (e.g., RAM 812) to processor 804. Computing system 800 can include a cache of high-speed memory 806 connected directly with, in close proximity to, or integrated as part of processor 804.

Processor 804 can include any general-purpose processor and a hardware service or software service, such as service 816, service 818, and service 820 stored in storage device 814, configured to control processor 804 as well as a special-purpose processor where software instructions are incorporated into the actual processor design. Processor 804 may essentially be a completely self-contained computing system, containing multiple cores or processors, a bus, a memory controller, a cache, etc. A multi-core processor may be symmetric or asymmetric.

To enable user interaction, computing system 800 includes an input device 826, which can represent any number of input mechanisms, such as a microphone for speech, a touch-sensitive screen for gesture or graphical input, keyboard, mouse, motion input, speech, etc. Computing system 800 can also include output device 822, which can be one or more of a number of output mechanisms known to those of skill in the art. In some instances, multimodal systems can enable a user to provide multiple types of input/output to communicate with computing system 800. Computing system 800 can include communication interface 824, which can generally govern and manage the user input and system output. There is no restriction on operating on any particular hardware arrangement, and therefore the basic features here may easily be substituted for improved hardware or firmware arrangements as they are developed.

Storage device 814 can be a non-volatile memory device and can be a hard disk or other types of computer-readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 814 can include software services, servers, services, etc., that when the code that defines such software is executed by the processor 804, it causes the system to perform a function. In some embodiments, a hardware service that performs a particular function can include the software component stored in a computer-readable medium in connection with the necessary hardware components, such as processor 804, connection 802, output device 822, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in a memory of a client device and/or one or more servers of a content management system and performs one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, e.g., instructions and data that cause or otherwise configure a general-purpose computer, special-purpose computer, or special-purpose processing device to perform a certain function or group of functions. Portions of computer resources used can be accessible over a network. The executable computer instructions may be, e.g., binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

### Aspects:

The present technology includes computer-readable storage mediums for storing instructions, and systems for executing any one of the methods embodied in the instructions addressed in the aspects of the present technology presented below:

Clause 1. A cooling system, comprising: a first cell having a plurality of subdivisions, wherein a subdivision of the plurality of subdivisions comprises a heat-producing system that produces heat, a heat-dissipating system providing a heat-removal capacity, and tubing conveying a coolant between the heat-producing system and the heat-dissipating system; one or more intra-cell valves connecting the tubing of respective subdivisions of the first cell, wherein the one or more intra-cell valves prevent fluid communication when in a closed state, and a first intra-cell valve of the one or more intra-cell valves provides fluid communication between a first subdivision and a second subdivision of the plurality of subdivisions, when in an open state; and a controller configured to control the one or more intra-cell valves based on heat-removal capacities of one or more heat-dissipating systems of the plurality of subdivisions.

Clause 2. The cooling system of clause 1, wherein: the controller is configured to determine a failing subdivision based on a failure of a cooling functionality occurring in the failing subdivision, and the controller is configured to provide excess cooling capacity from one or more non-failing subdivisions of the plurality of subdivisions to the failing subdivision by causing intervening intra-cell valve of the one or more intra-cell valves to be in the open state, the intervening intra-cell valve being between the failing subdivision and the one or more non-failing subdivisions.

Clause 3. The cooling system of clause 2, wherein: the failure of the cooling functionality occurs when the heat-removal capacity of the failing subdivision is less than the heat generated in the failing subdivision, and the excess cooling capacity of a non-failing subdivision is an amount that the heat-removal capacity of the non-failing subdivision exceeds the heat produced by the non-failing subdivision.

Clause 4. The cooling system of any of clause 1 through clause 3, wherein: a default condition for the one or more intra-cell valves to be in the closed state, and the controller is configurated to cause the one or more intra-cell valves to open in response to a determination to share cooling loads among the heat-dissipating systems of the plurality of subdivisions, and cause adjacent intra-cell valves to a quarantined subdivision in response to a determination to isolate a failing subdivision from other subdivisions of the plurality of subdivisions.

Clause 5. The cooling system of clause 4, wherein the determination to isolate the failing subdivision is based on an analysis that the other subdivisions lack sufficient excess cooling capacity to offset a cooling capacity deficit of the failing subdivision and/or an analysis that applying the excess cooling capacity of the other subdivisions that is sufficient to offset the cooling capacity deficit causes a risk of the other subdivisions failing.

Clause 6. The cooling system of clause 5, wherein the other subdivisions of the plurality of subdivisions have a common failure domain with the failing subdivision.

Clause 7. The cooling system of any of clause 1 through clause 6, wherein the cooling system includes a plurality of failure domains, a failure domain of the plurality of failure domains being a subset of subdivisions of the cooling system among which sharing excess cooling capacity between subdivision is limited to subdivisions within the subset of subdivisions.

Clause 8. The cooling system of clause 7, wherein the controller is configured to enforce a failure domain within a cell by maintaining boundary valves in the closed state, wherein the boundary valves include an intra-cell valve along a boundary between adjacent failure domains.

Clause 9. The cooling system of any of clause 1 through clause 8, wherein the controller is further configured to: obtain failure domains among the plurality of subdivisions, and maintain the one or more intra-cell valves in a closed state along boundaries between the failure domains, thereby isolating a failure domain from failures in other failure domains.

Clause 10. The cooling system of clause 9, wherein the controller is further configured to: updating the failure domains based on changes of equipment deployed in the heat-producing systems of the plurality of subdivisions.

Clause 11. The cooling system of any of clause 1 through clause 10, wherein the heat-dissipating system of the subdivision of the first cell includes a single coolant distribution unit (CDU).

Clause 12. The cooling system of any of clause 1 through clause 11, wherein the controller is configured to respond to the heat-removal capacity of the heat-dissipating system of the first subdivision being less than the heat produced by the heat-producing system of the first subdivision by, causing the first intra-cell valve to be in the open state, and causing the coolant to flow from the heat-dissipating system of the second subdivision to the heat-producing system of the first subdivision, thereby applying an excess cooling capacity of the second subdivision to remove heat from the first subdivision.

Clause 13. The cooling of clause 12, wherein the excess cooling capacity of a subdivision of the plurality of subdivisions is a difference between the heat-removal capacity of the heat-dissipating system and the heat produced by the heat-producing system of the subdivision.

Clause 14. The cooling system any of clause 1 through clause 13, further comprising: a second cell having a second plurality of subdivisions including a third subdivision; and one or more inter-cell valves including a first inter-cell valve that connects the tubing of the first cell to the tubing of the second cell, wherein the controller is further configured to cause the first inter-cell valve to open when there is a determination to apply an excess cooling capacity of the third subdivision to remove heat from one or more subdivisions of the first cell.

Clause 15. The cooling system of clause 14, wherein the controller is configured to: cause the first inter-cell valve to open based on a combined heat-removal capacity of the heat-dissipating systems of the first cell being less than a combined heat produced by the heat-producing systems of the first cell, and cause the coolant to flow from the heat-dissipating system of the third subdivision to the first cell, thereby applying the excess cooling capacity of the third subdivision to remove heat from the one or more subdivisions of the first cell.

Clause 16. The cooling system of clause 14, wherein the controller is configured to enforce a failure domain having a boundary between the first cell and the second cell by maintaining boundary valves in a closed state, wherein the boundary valves include the first inter-cell valve, which is along the boundary of the failure domain between the first cell and the second cell.

Clause 17. The cooling system of clause 2, wherein: the heat-producing system of the first subdivision comprises a first set of servers, the heat-producing system of the second subdivision comprises a second set of servers, the heat-dissipating system of the first subdivision comprises a first coolant distribution unit (CDU), and the heat-dissipating system of the second subdivision comprises a second CDU.

Clause 18. The cooling system of any of clause 1 through clause 17, wherein the controller is configured to compensate for a cooling capacity deficit in the first subdivision by: determining a combination of subdivisions of the first cell that has a combined excess cooling capacity exceeding the cooling capacity deficit of the first subdivision, and causing a set of intra-cell valves to open between the first subdivision and the combination of subdivisions, thereby applying the excess cooling capacity of the combination of subdivisions to cool the first subdivision, wherein the cooling capacity deficit of the first subdivision is a difference between the heat produced by the heat-producing system and the heat-removal capacity of the heat-dissipating system of the first subdivision.

Clause 19. The cooling system of clause 18, wherein the controller is further configured to: detect when the cooling capacity deficit of the first subdivision ceases such that the heat-removal capacity of the first subdivision exceeds the heat produced within the first subdivision, and cause the set of intra-cell valves to close.

Clause 20. The cooling system of clause 18, wherein the controller is further configured to: determine whether a combined heat produced by the first cell exceeds a combined heat-removal capacity of the first cell, determine that the determined combination of neighboring subdivisions includes the plurality of subdivisions of the first cell and at least one additional subdivision from one or more neighboring cells, when the combined heat produced by the first cell exceeds a combined heat-removal capacity of the first cell, cause inter-cell valves to open between the first cell and the one or more neighboring cells, and cause intra-cell valves to open between the first subdivision and the determined combination of neighboring subdivision, thereby applying the excess cooling capacity of the determined combination of subdivisions to cool the first subdivision of the first cell.

Clause 21. The cooling system of any of clause 1 through clause 20, wherein the controller is configured to compensate for a failed heat-dissipating system in the first subdivision of the first cell by: determining a combination of subdivisions from the first cell that has a combined excess cooling capacity exceeding the heat produced by the heat-dissipating system of the first subdivision to provide a combination of neighboring subdivisions, and causing a set of intra-cell valves to open between the first subdivision and the combination of subdivisions, thereby applying the excess cooling capacity of the combination of subdivisions to cool the first subdivision.

Clause 22. A method of cooling, the method comprising: monitoring cooling in subdivisions of a cooling system, the cooling system comprising a controller, one or more cells, which comprise respective subdivisions, and one or more intra-cell valves connecting tubing between respective subdivisions within a cell of the one or more cells, wherein a first cell of the cooling system comprises a first intra-cell valve and a plurality of subdivisions, a subdivision of the first plurality of subdivisions comprises a heat-producing system that produces heat, a heat-dissipating system providing heat-removal capacity, the tubing of the subdivision conveys a coolant from the heat-producing system to the heat-dissipating system, and the plurality of subdivisions includes a first subdivision and a second subdivision, wherein the first intra-cell valve connects the tubing of the tubing of the first subdivision with the tubing of the tubing of the second subdivision; and controlling, by the controller, the first intra-cell valve based on a heat-removal capacity of a heat-dissipating system of a first subdivision of the first plurality of subdivision.

Clause 23. The method of clause 22, further comprising: controlling, by the controller, the first intra-cell valve to open when the heat-removal capacity of the heat-dissipating system of the first subdivision is less than the heat produced by the heat-producing system of the first subdivision, the first intra-cell valve, when in an open state, providing fluid communication between the tubing of the first subdivision and the tubing of the second subdivision of the first plurality of subdivision; and causing, by the controller, the coolant to flow from a heat-dissipating system of the second subdivision to the heat-producing system of the first subdivision such that excess cooling capacity of the second subdivision is applied to remove heat from the heat-producing system of the first subdivision, wherein the excess cooling capacity of a subdivision being a difference between the heat-removal capacity of the heat-dissipating system and the heat produced by the heat-producing system of the subdivision.

Clause 24. The method of clause 22 or clause 23, further comprising: determining, by the controller, that a combined heat produced by the heat-producing systems of the first plurality of subdivisions exceeds a combined heat-removal capacity of the heat-dissipating systems of the first plurality of subdivisions; and controlling, by the controller, a first inter-cell valve to open between the first cell and a second cell, wherein, when in the open state, the first inter-cell valve provides fluid communication between the first cell and the second cell; and causing, by the controller, the coolant to flow from the first cell and the second cell, thereby applying excess cooling capacity of one or more subdivisions of the second cell to remove heat from the first cell.

Clause 25. The method of any of clause 22 through clause 24, wherein: the heat-producing systems of the first subdivision comprises a first set of servers, the heat-producing systems of the second subdivision comprises a second set of servers, the heat-dissipating system of the first subdivision comprises a first coolant distribution unit (CDU), and the heat-dissipating system of the second subdivision comprises a second CDU.

Clause 26. The method of any of clause 22 through clause 25, further comprising: determining, by the controller, that the first subdivision has a cooling capacity deficit, which is an amount of heat generated in the first subdivision that is not removed by the heat-dissipating system of the first subdivision; determining, by the controller, a combination of subdivisions of the first cell that have a combined excess cooling capacity sufficient to compensate for the cooling capacity deficit of the first subdivision; causing, by the controller, intra-cell valves to open between the first subdivision and the combination of subdivisions; and causing, by the controller, the coolant to flow from the combination of subdivisions to the first subdivision.

Clause 27. The method of clause 26, further comprising, when the combined excess cooling capacity of the first cell is insufficient to compensate for the cooling capacity deficit of the first subdivision: determining, by the controller, the combination of subdivisions from the first cell and from one or more cells that neighbor the first cell, such that have a combined excess cooling capacity of the combination of subdivisions is sufficient to compensate for the cooling capacity deficit of the first subdivision; causing, by the controller, a set of inter-cell valves to open between the first cell and the one or more cells that neighbor the first cell; causing, by the controller, a set of intra-cell valves to open between the first subdivision and the combination of subdivisions; and causing, by the controller, the coolant to flow from the combination of subdivisions to the first subdivision.

Clause 28. The method of clause 26, further comprising: determining, by the controller, that the cooling capacity deficit of the first subdivision has ceased such that the heat generated in the first subdivision that is removed by the heat-dissipating system of the first subdivision; and causing, by the controller, the intra-cell valves to open between the first subdivision and the combination of neighboring subdivisions to close, when the cooling capacity deficit of the first subdivision has ceased.

Clause 29. The method of any of clause 22 through clause 28, further comprising: obtaining, by the controller, failure domains among the subdivisions of the cooling system; and maintaining, by the controller, border valves in a closed state, the border valves being intra-cell valves and/or inter-cell valves demarking one or more boundaries between the failure domains.

Clause 30. The method of clause 29, updating, by the controller, the failure domains based on changes of equipment deployed in the heat-producing systems of the plurality of subdivisions.

Clause 31. The method of any of clause 22 through clause 30, further comprising: determining, by the controller, that a failure of the heat-dissipating system in a failing subdivision of the cooling system cannot be compensated by other heat-dissipating systems in other subdivisions within a same failure domain as the failing subdivision; overriding, by the controller, processes to compensate for the failure of the heat-dissipating system by maintaining intra-cell valves adjacent to the failing subdivision in a closed state; and ceasing operations of a heat-producing system of the failing subdivision while the failure of the heat-dissipating system persists.

Clause 32. The method of any of clause 22 through clause 31, wherein the heat-dissipating system of the subdivision of the first cell includes a single coolant distribution unit (CDU) without a backup CDU.

Clause 33. A controller of a cooling system, comprising: one or more processors; a communication system configured to communicate with one or more cells including a first cell comprising one or more intra-cell valves and a plurality of subdivisions, wherein a subdivision of the plurality of subdivisions comprises a heat-producing system that produces heat, a heat-dissipating system providing heat-removal capacity, and tubing conveying a coolant from the heat-dissipating system to the heat-producing system, and the one or more intra-cell valves prevent fluid communication when in a closed state; and a memory storing instructions that, when executed by the one or more processors, cause the controller to: monitor cooling in a first subdivision of the plurality of subdivisions based on first communications received from the first subdivision, and control the one or more intra-cell valve based on the heat-removal capacity of respective heat-dissipating systems of the plurality of subdivisions.

Clause 34. The controller of clause 33, wherein the instructions further cause the controller to: determine a failing subdivision of the plurality of subdivisions by detecting a failure of a cooling functionality occurring in the failing subdivision, and provide excess cooling capacity from a non-failing subdivision of the plurality of subdivisions to the failing subdivision by causing an intervening intra-cell valve of the one or more intra-cell valves to be in an open state, the intervening intra-cell valve being between the failing subdivision and the non-failing subdivision.

Clause 35. The controller of clause 34, wherein: the failure of the cooling functionality occurs when the heat-removal capacity of the failing subdivision is less than the heat generated in the failing subdivision, and the excess cooling capacity of the non-failing subdivision is an amount that the heat-removal capacity of the non-failing subdivision exceeds the heat produced by the non-failing subdivision.

Clause 36. The controller of any of clause 33 through clause 35, wherein the instructions further cause the controller to: communicate to the one or more cells a default state in which the one or more intra-cell valves are in the closed state, and cause an intra-cell valve of the one or more intra-cell valves to open in response to a determination to pass the coolant through the intra-cell valve from the heat-dissipating systems of a second subdivision of the plurality of subdivisions to the heat-producing systems of the first subdivision of the plurality of subdivisions, thereby applying an excess cooling capacity of the second subdivision to remove heat from the first subdivision.

Clause 37. The controller of clause 36, wherein the instructions further cause the controller to: determine a quarantined subdivision based on a determination to isolate a failing subdivision from other subdivisions of the plurality of subdivisions, and cause adjacent intra-cell valves adjacent to the quarantined subdivision to remain in a closed stated.

Clause 38. The controller of clause 37, wherein the determination to isolate the failing subdivision is based on an analysis that the other subdivisions lack sufficient excess cooling capacity to offset a cooling capacity deficit of the failing subdivision and/or an analysis that applying the excess cooling capacity of the other subdivisions that is sufficient to offset the cooling capacity deficit causes a risk of the other subdivisions failing.

Clause 39. The controller of any of clause 33 through clause 38, wherein the instructions further cause the controller to: obtain failure-domain information representing a failure-domain boundary between subdivisions and/or cells of the cooling system, the boundaries partitioning the cooling system into failure domains, and prevent any intra-cell valves demarking the boundaries from being in an open state, wherein a failure domain of the failure domains is a subset of subdivisions of the cooling system among which sharing excess cooling capacity is allowed but is limited to the subset of subdivisions within the failure domain.

Clause 40. The controller of clause 39, wherein the instructions further cause the controller to: enforce a failure-domain boundary within a cell of the one or more cells by maintaining a boundary intra-cell valve in a closed state, wherein the boundary intra-cell valve is an intra-cell valve of the plurality of intra-cell valves located along the failure-domain boundary between adjacent failure domains.

Clause 41. The controller of any of clause 33 through clause 40, wherein the instructions further cause the controller to: obtain failure-domain information representing a plurality of failure domains, and maintain in the closed state the one or more intra-cell valves that are along boundaries between adjacent failure domains of the plurality of failure domains, thereby isolating a failure domain from failures in other failure domains of the plurality of failure domains.

Clause 42. The controller of clause 41, wherein the instructions further cause the controller to: update the failure domains based on changes of equipment deployed in the heat-producing systems of the plurality of subdivisions.

Clause 43. The controller of any of clause 33 through clause 42, wherein the heat-dissipating system of the subdivision of the first cell includes a single coolant distribution unit (CDU).

Clause 44. The controller of any of clause 33 through clause 43, wherein the instructions further cause the controller to: respond to the heat-removal capacity of the heat-dissipating system of the first subdivision being less than the heat produced by the heat-producing system of the first subdivision by, causing the first intra-cell valve to be in an open state, and causing the coolant to flow from the heat-dissipating system of a second subdivision of the plurality of subdivisions to the heat-producing system of the first subdivision, thereby applying an excess cooling capacity of the second subdivision to remove heat from the first subdivision.

Clause 45. The controller of clause 44, wherein the excess cooling capacity of a subdivision is a difference between a heat-removal capacity of the heat-dissipating system and a heat produced by the heat-producing system of the subdivision.

Clause 46. The controller of clause 44, wherein: the heat-producing system of the first subdivision comprises a first set of servers, the heat-producing system of the second subdivision comprises a second set of servers, the heat-dissipating system of the first subdivision comprises a first coolant distribution unit (CDU), and the heat-dissipating system of the second subdivision comprises a second CDU.

Clause 47. The controller of any of clause 33 through clause 46, wherein: the cooling system further comprises a second cell and one or more inter-cell valves, wherein the second cell has a second plurality of subdivisions including a third subdivision and the one or more inter-cell valves includes a first inter-cell valve that connects the tubing of the first cell to the tubing of the second cell, and the instructions further cause the controller to cause the first inter-cell valve to open when there is a determination to apply an excess cooling capacity of the third subdivision to remove heat from one or more subdivisions of the first cell.

Clause 48. The controller of clause 47, wherein the instructions further cause the controller to: cause the first inter-cell valve to open based on a combined heat-removal capacity of the heat-dissipating systems of the first cell being less than a combined heat produced by the heat-producing systems of the first cell, and cause the coolant to flow from the heat-dissipating system of the third subdivision to the first cell, thereby applying the excess cooling capacity of the third subdivision to remove heat from the one or more subdivisions of the first cell.

Clause 49. The controller of any of clause 33 through clause 48, wherein, to compensate for a cooling capacity deficit of the first subdivision, the instructions further cause the controller to: determine a combination of subdivisions of the first cell that has a combined excess cooling capacity exceeding the cooling capacity deficit of the first subdivision, and cause a set of intra-cell valves to open between the first subdivision and the combination of subdivisions, thereby applying the excess cooling capacity of the combination of subdivisions to remove heat from the first subdivision, wherein the cooling capacity deficit of the first subdivision is a difference between the heat produced by the heat-producing system and the heat-removal capacity of the heat-dissipating system of the first subdivision.

Clause 50. The controller of clause 49, wherein the instructions further cause the controller to: detect that the cooling capacity deficit of the first subdivision has ceased such that the heat-removal capacity of the first subdivision exceeds the heat produced within the first subdivision, and cause the set of intra-cell valves to close.

Clause 51. The controller of clause 49, wherein cooling capacity deficit of the first subdivision is caused by the heat-dissipating system of the first subdivision ceasing to function such that the cooling capacity deficit of the first subdivision is the heat produced by the heat-producing system of the first subdivision and the excess cooling capacity of the combination of subdivisions exceeds the heat produced by the first subdivision.

Clause 52. The controller of clause 49, wherein the instructions further cause the controller to: determine whether a combined heat produced by the first cell exceeds a combined heat-removal capacity of the first cell, determine that the determined combination of neighboring subdivisions includes the plurality of subdivisions of the first cell and at least one additional subdivision from one or more neighboring cells, when the combined heat produced by the first cell exceeds a combined heat-removal capacity of the first cell, cause inter-cell valves to open between the first cell and the one or more neighboring cells, and cause intra-cell valves to open between the first subdivision and the determined combination of neighboring subdivision, thereby applying the excess cooling capacity of the determined combination of subdivisions to cool the first subdivision of the first cell.

Clause 53. The controller of any of clause 33 through clause 52, wherein, when in a closed state, a first intra-cell valve of the one or more intra-cell valves prevents fluid communication between a first subdivision and a second subdivision of the plurality of subdivisions.

Clause 54. The controller of clause 53, wherein the instructions further cause the controller to: cause the first intra-cell valve to be in an open state to provide fluid communication between the first subdivision and the second subdivision when on the heat-removal capacity of the heat-dissipating system of the first subdivision is less than the heat produced in the first cell, and cause coolant to flow from the heat-dissipating system of the second subdivision to the heat-producing system of the first subdivision thereby applying an excess cooling capacity of the second subdivision to remove heat from the first subdivision.

What is claimed is:

1. A cooling system, comprising:
a first cell having a plurality of subdivisions, wherein a subdivision of the plurality of subdivisions comprises a heat-producing system that produces heat, a heat-dissipating system providing a heat-removal capacity, and tubing conveying a coolant between the heat-producing system and the heat-dissipating system;
one or more intra-cell valves connecting the tubing of respective subdivisions of the first cell, wherein the one or more intra-cell valves prevent fluid communication when in a closed state, and, when in an open state, a first intra-cell valve of the one or more intra-cell valves provides fluid communication between a first subdivision and a second subdivision of the plurality of subdivisions; and
a controller configured to control the one or more intra-cell valves based on heat-removal capacities of one or more heat-dissipating systems of the plurality of subdivisions.

2. The cooling system of claim 1, wherein the controller is further configured to:
obtain failure domains among the plurality of subdivisions, and
maintain the one or more intra-cell valves in the closed state along boundaries between the failure domains, thereby isolating a failure domain from failures in other failure domains.

3. The cooling system of claim 2, wherein the controller is further configured to:
update the failure domains based on changes in equipment deployed in the heat-producing systems of the plurality of subdivisions.

4. The cooling system of claim 1, wherein the heat-dissipating system of the subdivision of the first cell includes a primary coolant distribution unit (CDU) without a backup CDU.

5. The cooling system of claim 1, wherein
the controller is configured to respond to the heat-removal capacity of the heat-dissipating system of the first subdivision being less than the heat produced by the heat-producing system of the first subdivision by,
causing the first intra-cell valve to be in the open state, and
causing the coolant to flow from the heat-dissipating system of the second subdivision to the heat-producing system of the first subdivision, thereby applying an excess cooling capacity of the second subdivision to remove heat from the first subdivision, wherein
the excess cooling capacity of the subdivision of the plurality of subdivisions is a difference between the heat-removal capacity of the heat-dissipating system and the heat produced by the heat-producing system of the subdivision.

6. The cooling system of claim 1, further comprising:
a second cell having a second plurality of subdivisions including a third subdivision; and
one or more inter-cell valves including a first inter-cell valve that connects the tubing of the first cell to the tubing of the second cell, wherein
the controller is further configured to cause the first inter-cell valve to open when there is a determination to apply an excess cooling capacity of the third subdivision to remove heat from one or more subdivisions of the first cell.

7. The cooling system of claim 6, wherein the controller is configured to:
cause the first inter-cell valve to open based on a combined heat-removal capacity of the heat-dissipating systems of the first cell being less than a combined heat produced by the heat-producing systems of the first cell, and
cause the coolant to flow from the heat-dissipating system of the third subdivision to the first cell, thereby applying the excess cooling capacity of the third subdivision to remove heat from the one or more subdivisions of the first cell.

8. The cooling system of claim 1, wherein the controller is configured to compensate for a cooling capacity deficit in the first subdivision by:
determining a combination of subdivisions of the first cell that has a combined excess cooling capacity exceeding the cooling capacity deficit of the first subdivision, and
causing a set of intra-cell valves to open between the first subdivision and the combination of subdivisions, thereby applying the excess cooling capacity of the combination of subdivisions to cool the first subdivision, wherein
the cooling capacity deficit of the first subdivision is a difference between the heat produced by the heat-producing system and the heat-removal capacity of the heat-dissipating system of the first subdivision.

9. The cooling system of claim 8, wherein the controller is further configured to:
detect when the cooling capacity deficit of the first subdivision ceases such that the heat-removal capacity of the first subdivision exceeds the heat produced within the first subdivision, and
cause the set of intra-cell valves to close.

10. The cooling system of claim 8, wherein the controller is further configured to:
determine whether a combined heat produced by the first cell exceeds a combined heat-removal capacity of the first cell,
determine that the combination of subdivisions includes the plurality of subdivisions of the first cell and at least one additional subdivision from one or more neighboring cells, when the combined heat produced by the first cell exceeds a combined heat-removal capacity of the first cell,
cause inter-cell valves to open between the first cell and the one or more neighboring cells, and
cause intra-cell valves to open between the first subdivision and the determined combination of subdivisions, thereby applying the excess cooling capacity of the determined combination of subdivisions to cool the first subdivision of the first cell.

11. A method of cooling, the method comprising:
monitoring cooling in subdivisions of a cooling system, the cooling system comprising a controller, one or more cells, which comprise respective subdivisions, and one or more intra-cell valves connecting tubing between respective subdivisions within a cell of the one or more cells, wherein
a first cell of the cooling system comprises a first intra-cell valve and a plurality of subdivisions,
a subdivision of the first plurality of subdivisions comprises a heat-producing system that produces heat, a heat-dissipating system providing heat-removal capacity, the tubing of the subdivision conveys a coolant from the heat-producing system to the heat-dissipating system, and
the plurality of subdivisions includes a first subdivision and a second subdivision, wherein the first intra-cell valve connects the tubing of the tubing of the first subdivision with the tubing of the tubing of the second subdivision; and
controlling, by the controller, the first intra-cell valve based on the heat-removal capacity of the heat-dissipating system of the first subdivision of the first plurality of subdivision.

12. The method of claim 11, further comprising:
determining, by the controller, that a combined heat produced by the heat-producing systems of the first plurality of subdivisions exceeds a combined heat-removal capacity of the heat-dissipating systems of the first plurality of subdivisions;
controlling, by the controller, a first inter-cell valve to open between the first cell and a second cell, wherein, when in an open state, the first inter-cell valve provides fluid communication between the first cell and the second cell; and
causing, by the controller, the coolant to flow from the first cell and the second cell, thereby applying excess cooling capacity of one or more subdivisions of the second cell to remove heat from the first cell.

13. The method of claim 11, further comprising:
determining, by the controller, that the first subdivision has a cooling capacity deficit, which is an amount of heat generated in the first subdivision that is not removed by the heat-dissipating system of the first subdivision;
determining, by the controller, a combination of subdivisions of the first cell that have a combined excess cooling capacity sufficient to compensate for the cooling capacity deficit of the first subdivision;
causing, by the controller, intra-cell valves to open between the first subdivision and the combination of subdivisions; and
causing, by the controller, the coolant to flow from the combination of subdivisions to the first subdivision.

14. The method of claim 13, further comprising, when the combined excess cooling capacity of the first cell is insufficient to compensate for the cooling capacity deficit of the first subdivision:
determining, by the controller, the combination of subdivisions from the first cell and from one or more cells that neighbor the first cell, such that have a combined excess cooling capacity of the combination of subdivisions is sufficient to compensate for the cooling capacity deficit of the first subdivision;
causing, by the controller, a set of inter-cell valves to open between the first cell and the one or more cells that neighbor the first cell;
causing, by the controller, a set of intra-cell valves to open between the first subdivision and the combination of subdivisions; and
causing, by the controller, the coolant to flow from the combination of subdivisions to the first subdivision.

15. The method of claim 11, further comprising:
obtaining, by the controller, failure domains among the subdivisions of the cooling system;
maintaining, by the controller, border valves in a closed state, the border valves being intra-cell valves and/or inter-cell valves demarking one or more boundaries between the failure domains; and
updating, by the controller, the failure domains based on changes of equipment deployed in the heat-producing systems of the plurality of subdivisions.

16. A controller of a cooling system, comprising:
one or more processors;
a communication system configured to communicate with one or more cells including a first cell comprising one or more intra-cell valves and a plurality of subdivisions, wherein a subdivision of the plurality of subdivisions comprises a heat-producing system that produces heat, a heat-dissipating system providing heat-removal capacity, and tubing conveying a coolant from the heat-dissipating system to the heat-producing system, and the one or more intra-cell valves prevent fluid communication when in a closed state; and
a memory storing instructions that, when executed by the one or more processors, cause the controller to:
monitor cooling in a first subdivision of the plurality of subdivisions based on first communications received from the first subdivision, and
control the one or more intra-cell valve based on the heat-removal capacity of respective heat-dissipating systems of the plurality of subdivisions.

17. The controller of claim 16, wherein the instructions further cause the controller to:
obtain failure-domain information representing a failure-domain boundary between subdivisions and/or cells of the cooling system, the boundaries partitioning the cooling system into failure domains,
prevent any intra-cell valves demarking the boundaries from being in an open state, wherein a failure domain of the failure domains is a subset of subdivisions of the cooling system among which sharing excess cooling capacity is allowed but is limited to the subset of subdivisions within the failure domain; and
enforce a failure-domain boundary within a cell of the one or more cells by maintaining a boundary intra-cell valve in a closed state, wherein the boundary intra-cell valve is an intra-cell valve of the plurality of intra-cell valves located along the failure-domain boundary between adjacent failure domains.

18. The controller of claim 16, wherein the instructions further cause the controller to:
respond to the heat-removal capacity of the heat-dissipating system of the first subdivision being less than the heat produced by the heat-producing system of the first subdivision by,
causing the first intra-cell valve to be in an open state, and
causing the coolant to flow from the heat-dissipating system of a second subdivision of the plurality of subdivisions to the heat-producing system of the first subdivision, thereby applying an excess cooling capacity of the second subdivision to remove heat from the first subdivision, wherein
the excess cooling capacity of a subdivision is a difference between a heat-removal capacity of the heat-dissipating system and a heat produced by the heat-producing system of the subdivision.

19. The controller of claim 16, wherein:
the cooling system further comprises a second cell and one or more inter-cell valves, wherein the second cell has a second plurality of subdivisions including a third subdivision and the one or more inter-cell valves includes a first inter-cell valve that connects the tubing of the first cell to the tubing of the second cell, and
the instructions further cause the controller to cause the first inter-cell valve to open when there is a determination to apply an excess cooling capacity of the third subdivision to remove heat from one or more subdivisions of the first cell.

20. The controller of claim 19, wherein the instructions further cause the controller to:
cause the first inter-cell valve to open based on a combined heat-removal capacity of the heat-dissipating systems of the first cell being less than a combined heat produced by the heat-producing systems of the first cell, and
cause the coolant to flow from the heat-dissipating system of the third subdivision to the first cell, thereby applying the excess cooling capacity of the third subdivision to cooling the one or more subdivisions of the first cell.
